(19) United States
(12) Patent Application Publication
(10) Pub. No.: US 2010/0257091 A1
(43) Pub. Date: Oct. 7, 2010

(54) SYSTEM AND METHOD FOR PRODUCING A REAL ESTATE LOAN APPLICATION

(76) Inventor: Marc L. Fletcher, Salt Lake City, UT (US)

Correspondence Address: GRANT R CLAYTON;CLAYTON HOWARTH & CANNON, PC, P O BOX 1909, SANDY, UT, 84091-1909, US

(21) Appl. No.: 12/576,222

(22) Filed: Oct. 8, 2009

Related U.S. Application Data
(60) Provisional application No. 61/103,903, filed on Oct. 8, 2008.

(51) Int. Cl. G06Q 40/00

(52) U.S. Cl. 705/38

(57) ABSTRACT

The present disclosure provides a system and method for processing information related to a financial transaction. The system provides for a centralized electronic database for storing and managing all necessary information for completing the financial transaction. This information may include, or relate to, a loan application, credit report, appraisal, and title report. The information is available over a computer network to all the major participants in a financial transaction, such as lenders, title companies, appraisers, and brokers. The system is also able to track changes in the information. In addition, certain automated features provide for a paperless transaction, including requesting, reviewing and even legally assigning the information residing in the database.

### CROSS-REFERENCE TO RELATED APPLICATIONS

This application claims the benefit of U.S. Provisional Application No. 61/103,903, filed Oct. 8, 2008, and entitled SYSTEM AND METHOD FOR PRODUCING A REAL ESTATE LOAN APPLICATION, which is hereby incorporated by reference herein in its entirety, including but not limited to those portions that specifically appear hereinafter, the incorporation by reference being made with the following exception: In the event that any portion of the above-referenced provisional application is inconsistent with this application, this application supercedes said above-referenced provisional application.

### STATEMENT REGARDING FEDERALLY SPONSORED RESEARCH OR DEVELOPMENT

Not Applicable.

### BACKGROUND

1. The Field of the Invention

The present disclosure relates generally to financial transactions, and more particularly, but not necessarily entirely, to automated methods and systems for gathering, storing and modifying information used in a financial transaction.

2. Description of Related Art

The process of completing a real estate loan involves pulling together information from multiple independent people and organizations. For example, a typical real estate loan may involve one or more borrowers, a mortgage broker, a loan processor, a title company, a closer, a lender, an underwriter, a credit scoring company and one or more appraisers. To date, the known methods for gathering, processing, and relaying vital information between the persons and entities involved in a real estate loan application have been fairly unsophisticated given the current level of available technology. For example, many loan applications are still completed by hand, information is sent through the mail or the information is transmitted via facsimile transmission.

Overall, there is a general lack of communication and awareness between persons involved in a real estate loan transaction. This lack of communication and awareness leads to redundant efforts, slower turn around, tension between the different persons and ultimately the loss of business. There is an acute need for streamlining the information sharing process during a loan application process to achieve greater efficiency in today's high volume loan market.

Another drawback to the traditional methods used in processing a loan application is that they provide only a small portion of the available information. That is, due to the cumbersome methods used to gather, retain, and transfer information, the tendency has been to keep the amount of information to a bare minimum. This is disadvantageous since additional information, if available, may help identify high risk loans before the loan is closed. For example, in the past, real estate appraisers have provided relatively limited information to the underwriter when valuing a home. This may lead to a loan being granted at a higher loan-to-value than would otherwise be acceptable to the lender and increases the chance for more fraudulent loans. For example, if an underwriter could view a diagram of the home with 360 degree tours, still photos of each room in the house, and street views of the house and neighborhood then the underwriter could more easily determine whether or not the appraisal of the home is reasonable and whether or not to proceed with underwriting the loan or to seek a second appraisal. As another example, it would be advantageous to have a system in place for tracking a borrower's credit report over time (e.g., before and after the borrower, mortgage broker, or credit agency has initiated or made corrections to the credit report) to allow lenders and underwriters to review/research why an item was corrected or removed from a credit report to avoid untrustworthy or fraudulent activity.

Another disadvantage with the traditional loan application process is the lack of automation. For example, when an appraisal is needed for a particular property, typically the mortgage broker obtains a list of appraisers working in the general geographic location of the property, and calls each one individually. This process can become overly time consuming. The process for selecting a title company to use for a particular transaction can be cumbersome and time consuming as well.

Another disadvantage is the lack of a complete solution to handle all of the various aspects of a real estate loan application, including the loan application, title report, underwriter approval, appraisal, credit documents, etc. In the past, each of these aspects have been separately managed. It would be useful to provide a complete solution in an integrated and centralized package to handle all aspects of a loan application.

The previous methods are thus characterized by several disadvantages that are addressed by the present disclosure. The present disclosure minimizes, and in some aspects eliminates, the above-mentioned failures, and other problems, by utilizing the methods and structural features described herein.

The features and advantages of the disclosure will be set forth in the description which follows, and in part will be apparent from the description, or may be learned by the practice of the disclosure without undue experimentation. The features and advantages of the disclosure may be realized and obtained by means of the instruments and combinations particularly pointed out in the appended claims.

### BRIEF DESCRIPTION OF THE DRAWINGS

The features and advantages of the disclosure will become apparent from a consideration of the subsequent detailed description presented in connection with the accompanying drawings in which:

FIG. 1 is a diagram of one exemplary embodiment of the present disclosure;

FIG. 1A is a diagram of another exemplary embodiment of the present disclosure;

FIG. 2 is a block diagram of an exemplary terminal;

FIG. 3 is a flow diagram of one exemplary portion of the present disclosure;

FIG. 4 is an exemplary screen view in accordance with the present disclosure;

FIG. 5 is an exemplary menu in accordance with the present disclosure;

FIG. 6 is an exemplary menu in accordance with the present disclosure;

FIG. 7 is an exemplary menu in accordance with the present disclosure;

FIG. 8 is an exemplary menu in accordance with the present disclosure;

FIG. 9 is an exemplary menu in accordance with the present disclosure;

FIG. 10 is an exemplary menu in accordance with the present disclosure;

FIG. 11 is an exemplary menu in accordance with the present disclosure;

FIG. 12 is an exemplary menu in accordance with the present disclosure;

FIG. 13 is an exemplary menu in accordance with the present disclosure;

FIG. 14 is an exemplary menu in accordance with the present disclosure;

FIG. 15 is an exemplary electronic notification in accordance with the present disclosure;

FIG. 16 is an exemplary screen view in accordance with the present disclosure;

FIG. 17 is an exemplary menu in accordance with the present disclosure;

FIG. 18 is an exemplary menu in accordance with the present disclosure;

FIG. 19 is an exemplary menu in accordance with the present disclosure;

FIG. 20 is an exemplary flow chart in accordance with the present disclosure;

FIG. 21 is an exemplary screen view in accordance with the present disclosure;

FIG. 22 is an exemplary request for appraisal in accordance with the present disclosure;

FIG. 23 is an exemplary menu in accordance with the present disclosure;

FIG. 24 is an exemplary electronic notification in accordance with the present disclosure;

FIG. 25 is an exemplary screen view in accordance with the present disclosure;

FIG. 26 is an exemplary menu in accordance with the present disclosure;

FIG. 27 is an exemplary screen view in accordance with the present disclosure;

FIG. 28 is an exemplary diagram of an appraisal layout in accordance with the present disclosure;

FIG. 29 is an exemplary screen view in accordance with the present disclosure;

FIG. 30 is an exemplary electronic notification in accordance with the present disclosure;

FIG. 31 is an exemplary screen view in accordance with the present disclosure;

FIG. 32 is an exemplary menu in accordance with the present disclosure;

FIG. 33 is an exemplary diagram of an appraisal layout in accordance with the present disclosure;

FIG. 34 is an exemplary screen view in accordance with the present disclosure;

FIG. 35 is an exemplary electronic notification in accordance with the present disclosure;

FIG. 36 is an exemplary screen view in accordance with the present disclosure;

FIG. 37 is an exemplary menu in accordance with the present disclosure;

FIG. 38 is an exemplary diagram of an appraisal layout in accordance with the present disclosure;

FIG. 39 is an exemplary screen view in accordance with the present disclosure;

FIG. 40 is an exemplary menu in accordance with the present disclosure;

FIG. 41 is an exemplary diagram of an appraisal layout in accordance with the present disclosure;

FIG. 42 is an exemplary screen view in accordance with the present disclosure;

FIG. 43 is an exemplary menu in accordance with the present disclosure;

FIG. 44 is an exemplary screen view in accordance with the present disclosure;

FIG. 45 is an exemplary menu in accordance with the present disclosure;

FIG. 46 is an exemplary screen view in accordance with the present disclosure;

FIG. 47 is a flow diagram in accordance with the present disclosure;

FIG. 48 is an exemplary screen view in accordance with the present disclosure;

FIG. 49 is an exemplary request for title in accordance with the present disclosure;

FIG. 50 is an exemplary menu in accordance with the present disclosure;

FIG. 51 is an exemplary electronic notification in accordance with the present disclosure;

FIG. 52 is an exemplary screen view in accordance with the present disclosure;

FIG. 53 is an exemplary menu in accordance with the present disclosure;

FIG. 54 is an exemplary screen view in accordance with the present disclosure;

FIG. 55 is an exemplary menu in accordance with the present disclosure;

FIG. 56 is an exemplary electronic notification in accordance with the present disclosure;

FIG. 57 is an exemplary screen view in accordance with the present disclosure;

FIG. 58 is an exemplary menu in accordance with the present disclosure;

FIG. 59 is an exemplary menu in accordance with the present disclosure;

FIG. 60 is an exemplary electronic notification in accordance with the present disclosure;

FIG. 61 is an exemplary screen view in accordance with the present disclosure;

FIG. 62 is an exemplary menu in accordance with the present disclosure; and

FIG. 63 is an exemplary menu in accordance with the present disclosure.

### DETAILED DESCRIPTION

For the purposes of promoting an understanding of the principles in accordance with the disclosure, reference will now be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure claimed.

It must be noted that, as used in this specification and the appended claims, the singular forms “a,” “an,” and “the” include plural referents unless the context clearly dictates otherwise.

In describing and claiming the present disclosure, the following terminology will be used in accordance with the definitions set out below. As used herein, the terms “comprising,” “including,” “containing,” “characterized by,” and grammatical equivalents thereof are inclusive or open-ended terms that do not exclude additional, unrecited elements or method steps.

The following is a glossary of common terms used in the financial industry which will be used herein:

Loan Application: Document required by lenders prior to loan approval containing detailed information about the borrower and property.

Mortgage Broker: An individual or company that (usually for a fee) acts as an intermediary between borrowers and lenders.

Lender: The individual, party or financial institution from whom the money is actually borrowed. Also known as the mortgagee, in the case of a mortgage loan. A lender may lend directly to a borrower or indirectly through a mortgage broker.

Borrower: An individual who makes an application for and receives funds in the form of a loan and is obligated to repay the loan in full under the conditions of the loan.

Appraisal: An opinion of value reached by an appraiser based upon recent sales information for similar properties, the condition of the property and the neighborhood's impact on future property value.

Appraiser: The person who decides the market value of a home based on its condition and the selling prices of comparable homes recently sold in the area. The appraiser computes a fair estimate of market value to help the lender decide a reasonable loan amount.

Title Report: A document indicating the current state of title for real property. The title report includes information on the current ownership, outstanding deeds of trust or mortgages, liens, easements, covenants, restrictions, and any defects.

Title Company: A business or law firm that examines real property titles, reports its findings as to the legal status of such titles, and issues insurance policies to indemnify the owner and lender against financial loss resulting from unknown title defects or prior claims against the property.

Credit Report: A report to a prospective lender on the credit standing of a prospective borrower. Used to help determine creditworthiness. Information regarding late payments, defaults, or bankruptcies will appear in the credit report.

Credit Agency: An agency that compiles and distributes credit and personal information to creditors and lenders. This information may include payment habits, number of credit accounts, balance of accounts, and length and place of employment. The three largest credit bureaus in the U.S. are Equifax, Experian and TransUnion.

Underwriter: A person who approves or denies a loan to a potential borrower based on the borrower's credit history, employment history, assets, debts, the subject property, appraisal and other factors such as loan guidelines.

The present disclosure relates to a system and method for completing a real estate transaction. The system includes hardware and software adapted to facilitate the exchange of information between the various persons/entities involved in completing a real estate loan transaction, namely the mortgage broker, the appraiser, the title company, the credit agency, the underwriter and the lender. It will be appreciated that the system may be expanded, according to the present disclosure, to include other necessary entities and/or employees of these entities. For example, loan officers and loan processors may work for the mortgage broker. Underwriters may be employed by the lender. Closing agents, title officers and title searchers may be employed by the title company.

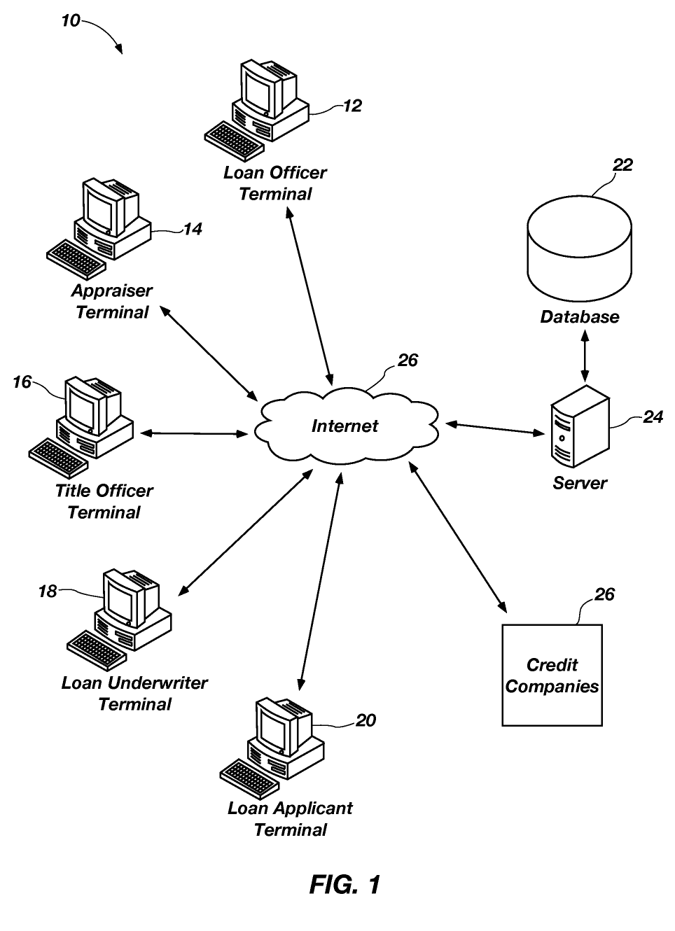

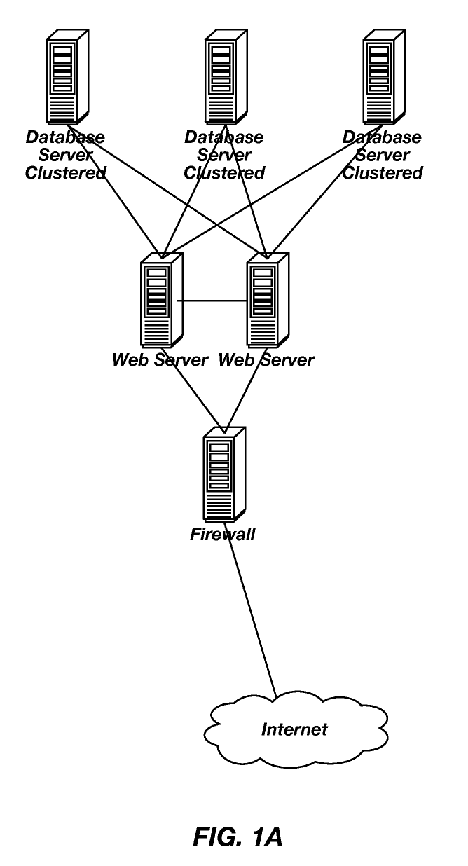

Referring now to FIG. 1, there is shown an exemplary system 10 for carrying out the objectives of the present invention. Terminals 12, 14, 16, 18, and 20 allow shared access to information residing in database 22 through server 24. Server 24 is sometimes referred to herein as a central processing unit or central processing means. Further, as will be explained in detail hereinafter, the information residing in the database may include loan applications, appraisals, credit reports, title reports, closing documents, loan applicant information and other information used in the loan application process. Terminals 12 through 20 may access the information through a network such as the internet 26. It will be appreciated that other networks may be used as well, including LANs and WANs.

Terminals 12 through 20 allow mortgage brokers, loan officers, appraisers, title officers, loan underwriters, and the loan applicant to access, enter, and modify the information residing on database 22. It will be appreciated that other people or entities may be granted access to the information residing on database 22. For example, a lender or a loan servicing company may have access to the information on database 22. It will be further appreciated that each of the terminals 12 through 20 may be located at different physical locations.

The server 24 allows each of the terminals to access the information in the database 22. In addition, the server 24 may operate as a collection of servers, including database servers, web servers, and application servers. Server 24 may also be a central processing unit or central processing means. As a web server, server 24 is a computer connected to the World Wide Web (connected to the Internet Backbone) that stores HTML documents that can be retrieved via a web browser typically running on a terminal. These HTML documents may provide a graphical user interface (GUI) to allow easy and organized access to the information residing in database 22. It will be appreciated that the access may be password protected. Thus, to access the information on the database 22, a login name and a password may be required. In addition, different levels of access may be granted depending on the requirements of any individual person. For example, an appraiser may only have access to appraisal information and not to the loan applicant's personal financial information. Likewise, a loan underwriter may be granted access to all the information residing in the database.

In addition to the features outlined above, the present invention also provides a communication means between the individuals involved in a loan transaction. That is, the loan officer may leave the appraiser a message by using the present system. The message is stored in database 22 and the appraiser may be notified of the message via email, phone message, text message, paging, or the next time the appraiser logs into the system.

Through the use of a centralized database 22, information may be more easily shared between the concerned parties. Further, one particularly beneficial feature of the present invention is the reduction of paperwork typically associated with a loan transaction. Additionally, the system may be configured to require more information than is traditionally used in a loan application process. Also, the present invention allows tracking of changes to the information entered into the database 22 over time.

As seen in FIG. 1, credit companies 26 may also be connected to system 10 via the internet 26 or by some other network. This allows the credit information of a loan applicant to be downloaded and stored in database 22.

FIG. 1A illustrates another embodiment of the present invention, including database servers, web servers, a firewall and the internet. These devices have the features of the similar devices described above or are well known to those having skill in the art. Thus, it will be appreciated that the configuration of a system according to the present invention may take various forms, and the intelligence of such a system may reside in a single computing device or may be spread among several computing devices.

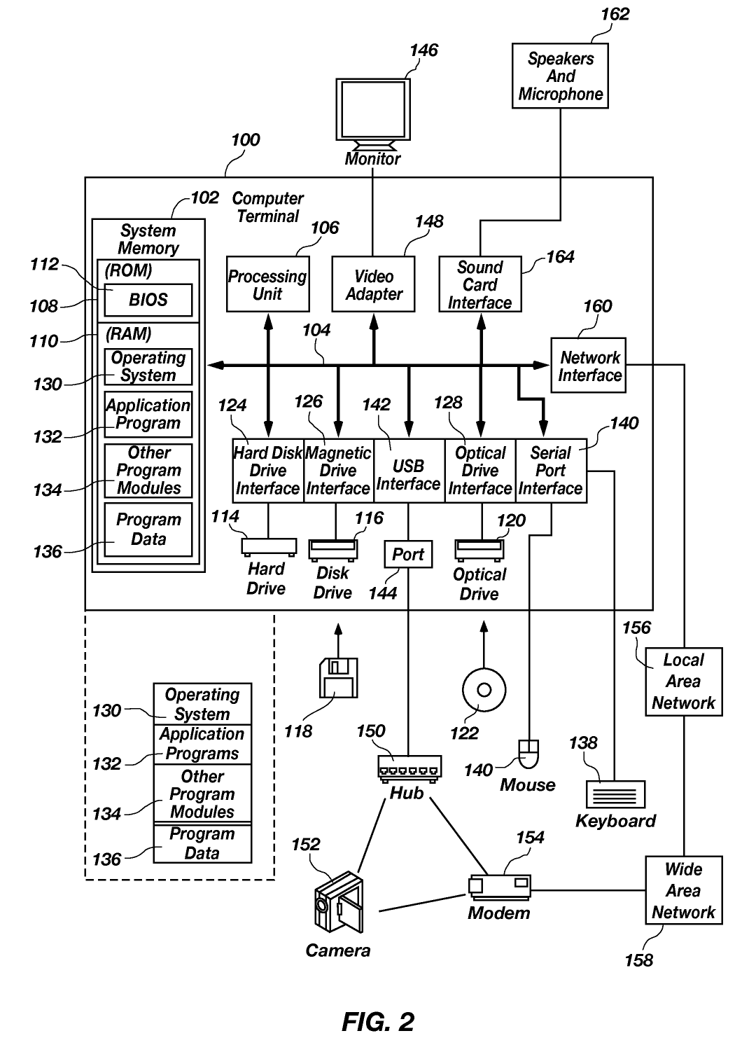

Referring now to FIG. 2, there is shown an exemplary embodiment of a computer terminal 100, that may be used for the terminals 12 through 20. It will be appreciated that other embodiments of the terminals 12 and 20 having more or less features than shown in FIG. 2 may be used in accordance with the present disclosure as is known by those having relevant skill in the art.

The computer terminal 100 includes a system memory 102, and a system bus 104 that interconnects various system components including the system memory 102 to the processing unit 106. The system bus 104 may be any of several types of bus structures including a memory bus or memory controller, a peripheral bus, and a local bus using any of a variety of bus architectures as is known to those skilled in the relevant art. The system memory includes read only memory (ROM) 108 and random access memory (RAM) 110. A basic input/output system (BIOS) 112, containing the basic routines that help to transfer information between elements within the computer terminal 100, such as during start-up, is stored in ROM 108. The computer terminal 100 may further include a hard disk drive 114 for reading and writing information to a hard disk (not explicitly illustrated), a magnetic disk drive 116 for reading from or writing to a removable magnetic disk 118, and an optical disk drive 120 for reading from or writing to a removable optical disk 122 such as a CD ROM, DVD, or other optical media.

The hard disk drive 114, magnetic disk drive 116, and optical disk drive 120 are connected to the system bus 104 by a hard disk drive interface 124, a magnetic disk drive interface 126, and an optical disk drive interface 128, respectively. The drives and their associated computer-readable media provide nonvolatile storage of computer readable instructions, data structures, program modules and other data for the computer terminal 100. Although the exemplary environment described herein employs a hard disk, a removable magnetic disk 118, and a removable optical disk 122, it will be appreciated by those skilled in the relevant art that other types of machine readable media which can store data that is accessible by a processor, such as magnetic cassettes, flash memory cards, digital video disks, Bernoulli cartridges, random access memories, read only memories, and the like which may now be available or which become available in the future, may also be used in the exemplary operating environment.

A number of program modules may be stored on the hard disk, magnetic disk 118, optical disk 122, ROM 108 or RAM 110, including an operating system 130, one or more applications programs 132, other program modules 134, and program data 136. A user may enter commands and information into the computer terminal 100 through input devices such as a keyboard 138 and a pointing device 140, such as a mouse. Other input devices (not explicitly illustrated) may include a joystick, game pad, satellite dish, scanner, or the like. These and other input devices are often connected to the processing unit 106 through a serial port interface 140 that is coupled to the system bus 104. Increasingly, such devices are being connected by the next generation of interfaces, such as a universal serial bus (USB) interface 142 with a USB port 144, and to which other hubs and devices may be connected. Other interfaces (not explicitly illustrated) that may be used include parallel ports, game ports, and the IEEE 1394 (Firewire) specification.

A monitor 146 or other type of display device is also connected to the system bus 104 via an interface, such as a video adapter 148. In addition to the monitor 146, computer terminals 100 typically include other peripheral output or input devices. The USB connections illustrate its utility. A USB hub 150 is shown connected to the USB port 144. The hub 150 may in turn be connected to other devices such as a web camera 152 and modem 154. Although not explicitly illustrated, it is well understood by those having the relevant skill in the art that a keyboard, scanner, printer, external drives (e.g., hard disk and optical disc) and a pointing device may be connected to the USB port 144 or the hub 150. Thus, it should be understood that additional cameras and devices may be directly connected to the computer through the USB port 144. Thus, the system depicted is capable of communicating with a network and sending/receiving audio, video and other types of data.

The computer terminal 100 may operate in a networked environment using logical connections to one or more remote computers. The types of connections between networked devices include dial up modems, e.g. modem 154 may be directly used to connect to another modem, ISDN, xDSL, cable modem, wireless and include connections spanning users connected to the Internet. The remote computer may be another personal computer, a server, a router, a network PC, a peer device or other common network node, and typically includes many or all of the elements described above relative to the computer terminal 100 in FIG. 2. The logical connections depicted in FIG. 2 include a local area network (LAN) 156 and a wide area network (WAN) 158. Such networking environments are commonplace in offices, enterprise-wide computer networks, intranets and the Internet.

When used in a LAN networking environment, the computer terminal 100 is connected to the local network 156 through a network interface or adapter 160. When used in a WAN networking environment, the computer terminal 100 typically uses modem 154 or other means for establishing communications over the wide area network 158. It should be noted that modem 154 may be internal or external and is connected to the system bus 104 through USB port 144. A modem may optionally be connected to system bus 104 through the serial port interface 140. It will be appreciated that the network connections shown are exemplary and other means of establishing a communications link between the computers may be used, e.g., from a LAN gateway to WAN.

The computer terminal 100 may also receive audio input from a microphone and output audio sounds through speakers as illustratively shown by the box marked with the reference numeral 162 in FIG. 2. A sound card interface 164 processes the sounds to a sound card and the system bus 164. Further, the computer terminal 100 may take many forms as is known to those having relevant skill in the art, including a desktop personal computer, a laptop computer, a handheld computer, and the like. Further, the computer compatibility of the computer terminal 100 may include, without limitation, IBM PC/XT/AT, or compatibles, or Apple Macintosh computers. The operating system 130 compatibility may include, without limitation, MS-DOS, MS-Windows, Unix, or Macintosh.

Generally, the data processors of computer terminal 100 are programmed by means of instructions stored at different times in the various computer-readable storage media of the computer. Programs and operating systems are typically distributed, for example, on optical media. From there, they are installed or loaded into the secondary memory of a computer. At execution, they are loaded at least partially into the computer's primary electronic memory. The present disclosure described herein includes these and other various types of computer-readable storage media when such media contain instructions or programs for implementing the steps described herein in conjunction with a microprocessor or other data processor. The present disclosure also includes the computer itself when programmed according to the methods and techniques described herein.

The computer terminal 100 may have loaded into memory a web browser, which is an application program that provides a way to look at and interact with the information on the World Wide Web. Netscape and Microsoft Internet Explorer are examples of two types of browsers that may be used.

The server 24 may also take substantially the same form as the computer terminal 100 shown in FIG. 2. The server 24, in its simplest form, is a computer that stores Web documents and makes them available to the rest of the world over the World Wide Web. The server 24 may be dedicated, meaning its sole purpose is to be a web server, or non-dedicated, meaning it can be used for basic computing in addition to acting as a server. In one embodiment, the main body of software used with the present disclosure resides on the server 24. Software may also reside on the terminals 12 through 20.

The present system may include various software modules to accomplish specific tasks associated with the loan application process. The various modules may include, without limitation an application module, appraisal module, a title module, and a credit module. A module may include associated web pages to facilitate the function of the module.

In many of the figures discussed hereafter, reference is made to a particular “slide.” Such slide references in the figures are intended to refer to particular figures herein. Set forth below is the translation of the slide reference numeral to the figure number.

| Slide Reference | Figure Number |
|---|---|
| 5 | 7 |
| 6 | 8 |
| 7 | 9 |
| 8 | 10 |
| 9 | 11 |
| 10 | 12 |
| 11 | 13 |
| 12 | 14 |
| 13 | 15 |

The Credit Module

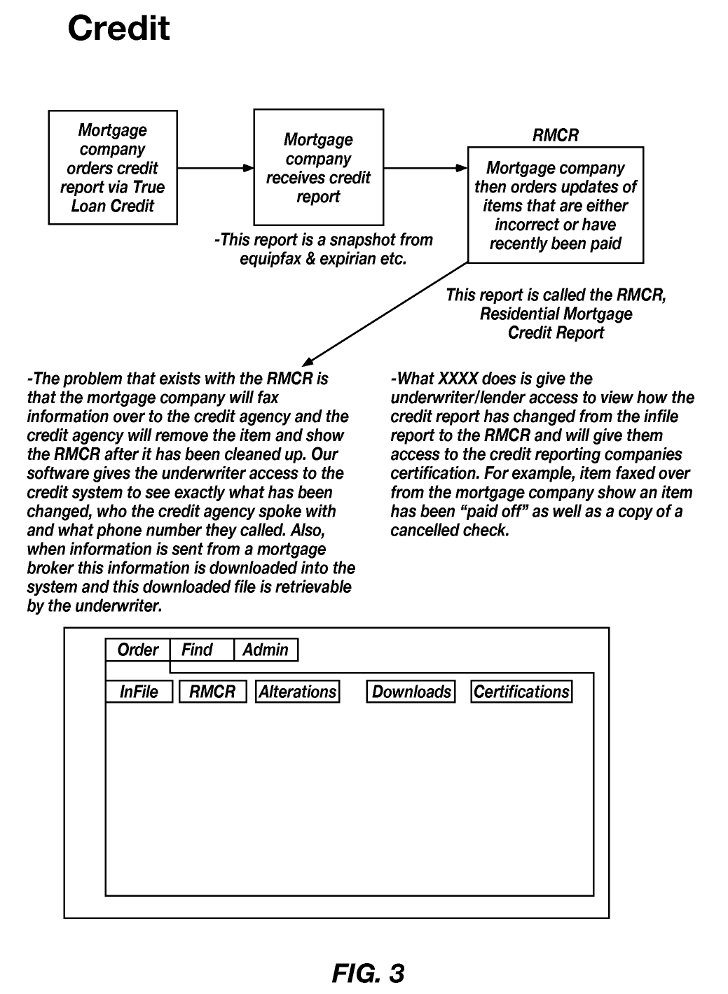

Referring now to FIG. 3, there is shown an illustrative embodiment of a credit module. The purpose of the credit module is to receive, manage, and track changes to credit reports. The mortgage company may order a credit report from the credit companies 26 through the loan officer terminal 12. The credit report order may go through server 24 running applicant's software program. The credit report can be received and stored in database 22. The credit report may be viewed by operators of terminals 12-20. As is often the case, the credit report may contain incorrect information regarding the loan applicant's credit history. The loan officer may then work with the loan applicant through procedures established by the credit agency to remove incorrect information from the credit report. The credit agency will then correct the loan applicant's credit report and issue a revised credit report, which may also be stored in database 22. The credit module preferably provides a summary of the changes to the credit report and give exact information regarding the change as explained below.

It has been previously unknown in the industry to track the changes to the credit report such that the other entities involved in the loan transactions can easily access and verify the changes. In particular, the present system will identify how the credit report has been changed and in addition will give access to the credit reporting company certification. Copies of the supporting documents underlying the change in the credit report may also be made available as well. For example, a letter from a creditor showing that the account has been paid off or a copy of a cancelled check showing that the “account” has been paid off may be made available.

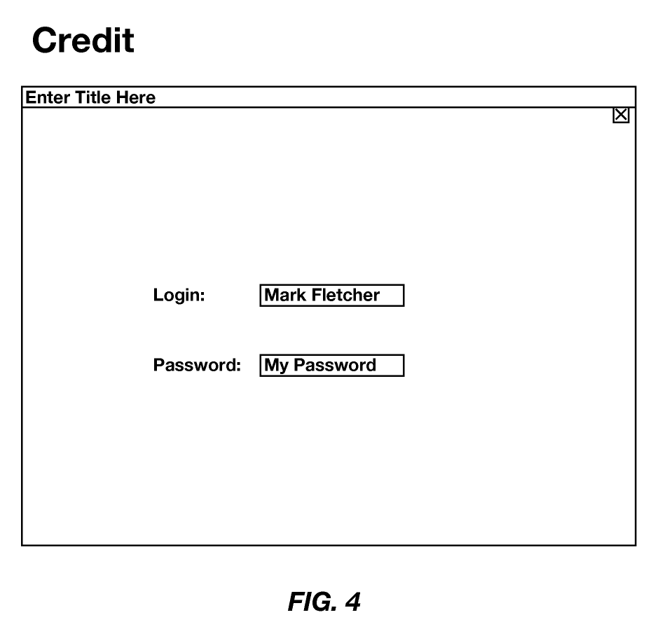

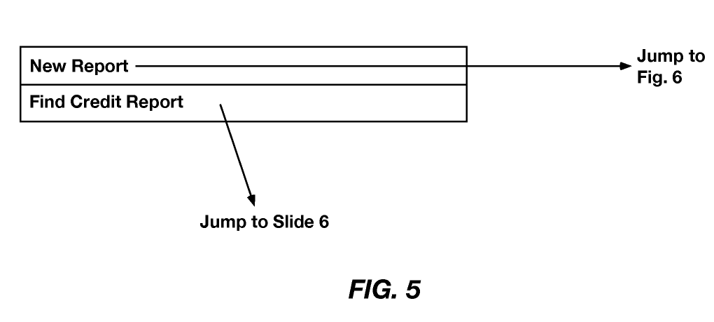

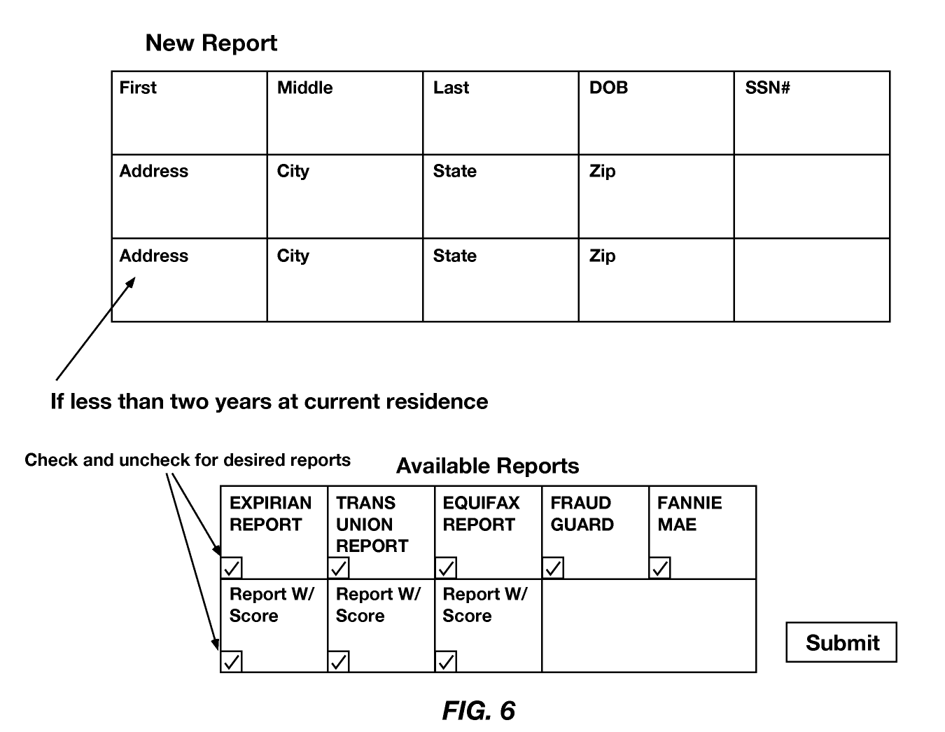

FIG. 4 illustrates an exemplary login page including a login name and password. FIG. 5 illustrates an exemplary menu for allowing the creation of a new credit report file or to find an existing credit report file. FIG. 6 is an exemplary order page for ordering a credit report. The loan officer may enter in the loan applicant's required information to order a credit report. In addition, the loan officer may select to order any available credit report offered by the credit agencies.

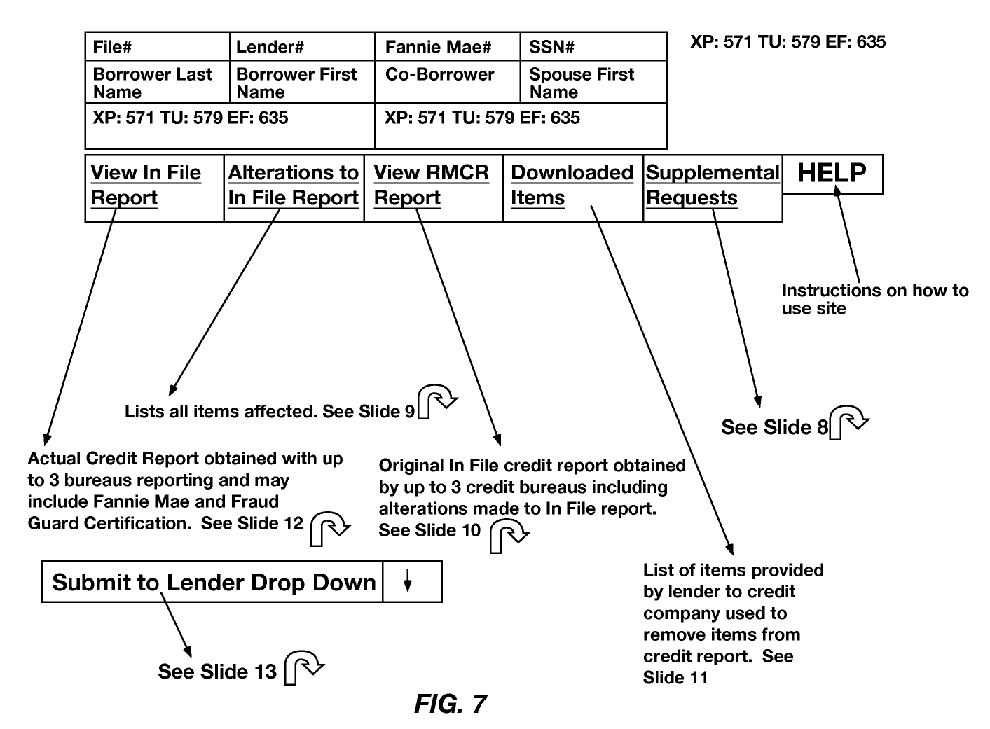

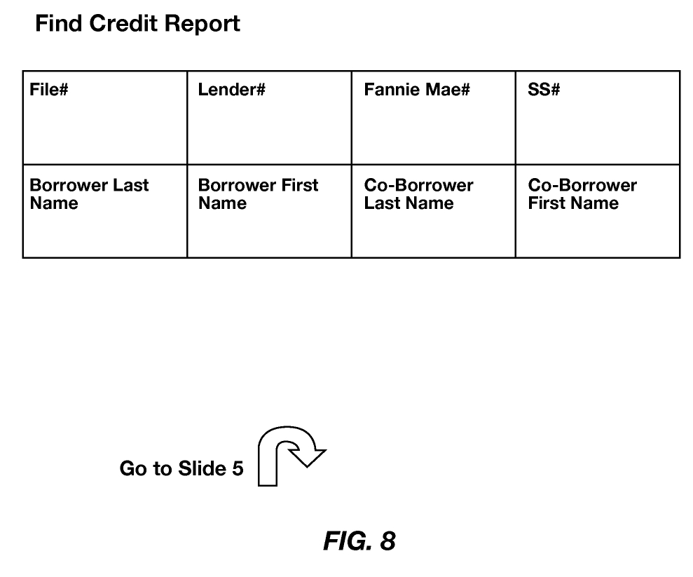

FIG. 7 shows a page that may be displayed once a credit report is received from one or more credit agencies. The loan applicant's credit scores may be displayed and a menu bar may allow viewing of the actual credit report. Another link preferably allows viewing of any alterations to the credit report. Another link may allow viewing of the Residential Mortgage Credit Report (RMCR) report. FIG. 8 illustrates a sample search screen to find and locate credit reports of individual borrowers in the system.

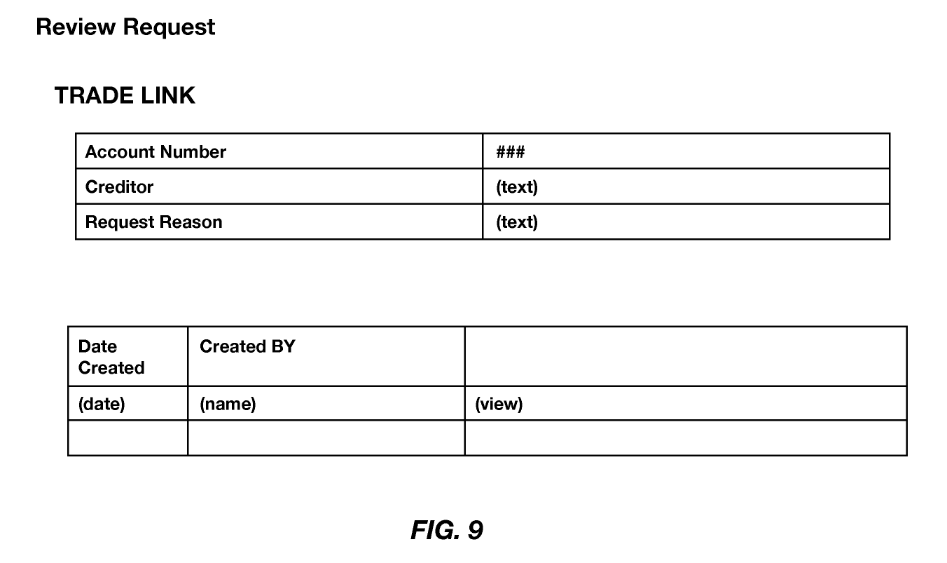

FIG. 9 illustrates a menu that allows for the request of a review of an account on the credit report. The account number, name of creditor, and an explanation for the request may be specified. For example, if the account has been paid off but is still showing as open on the credit report, then a request for review may be made using the present system. This information may then be automatically sent to the appropriate credit agency to review the account accuracy. The credit agency may then issue a supplemental report which is preferably stored in database 22.

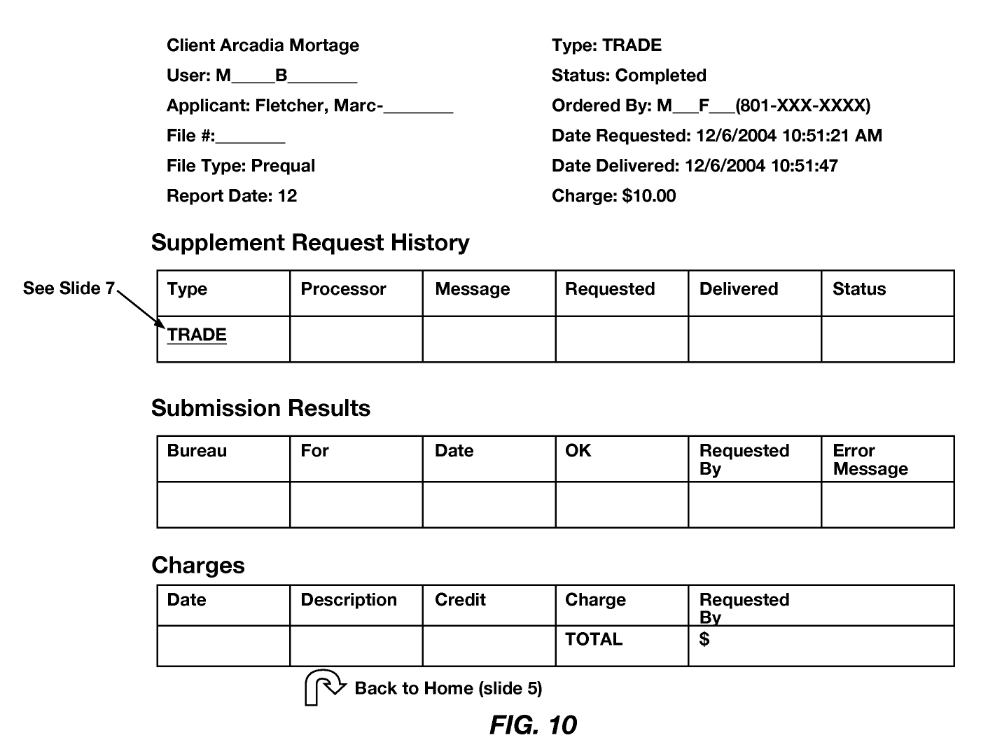

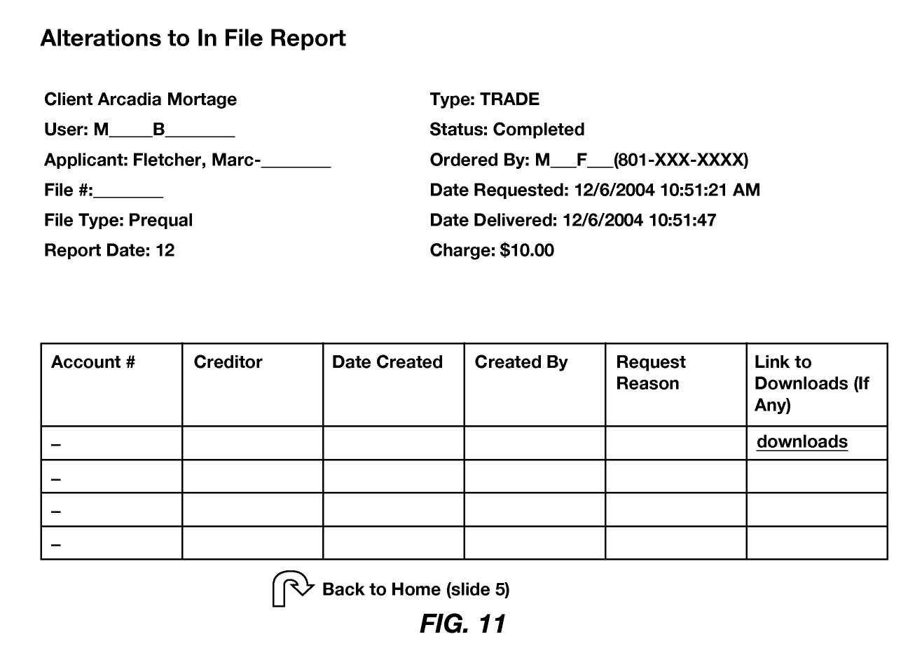

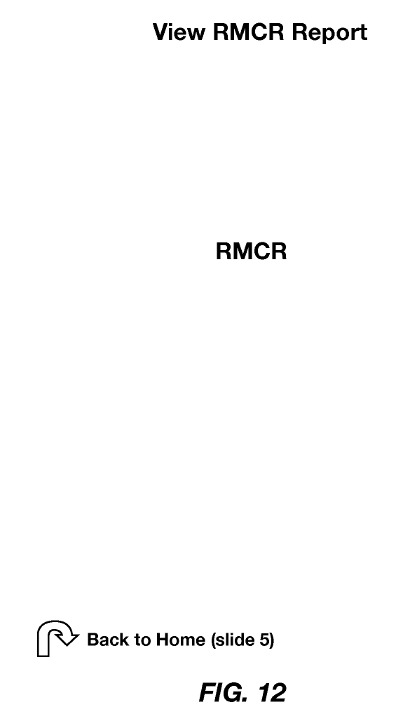

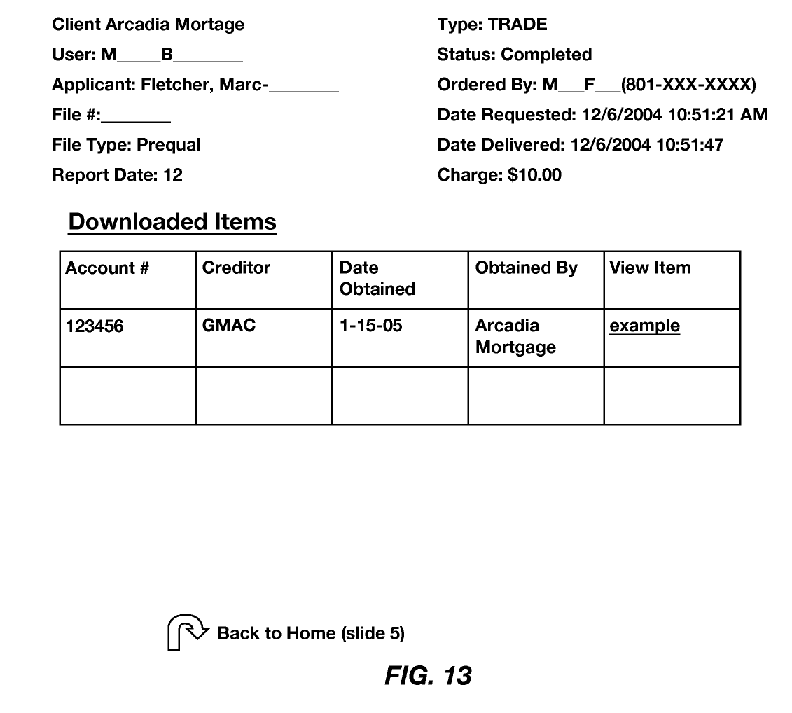

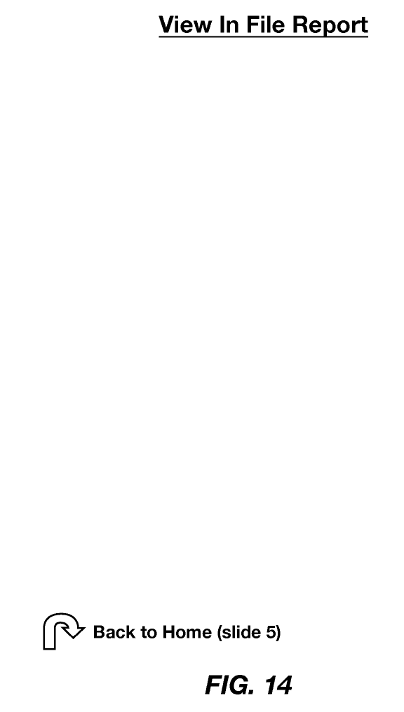

FIG. 10 illustrates an exemplary menu for displaying the status of the request for review and also any charges associated with the request. FIG. 11 illustrates an exemplary menu showing the alterations in the credit report. It may show the account number, the name of the creditor, the date created, the created by, the reason for the request, as well as a link to any supporting documentation, such as proof of payoff (cancelled check). FIG. 12 illustrates a menu for allowing the viewing of an RMCR. FIG. 13 illustrates a menu for viewing the status of the request. FIG. 14 represents and exemplary menu for viewing the in file report.

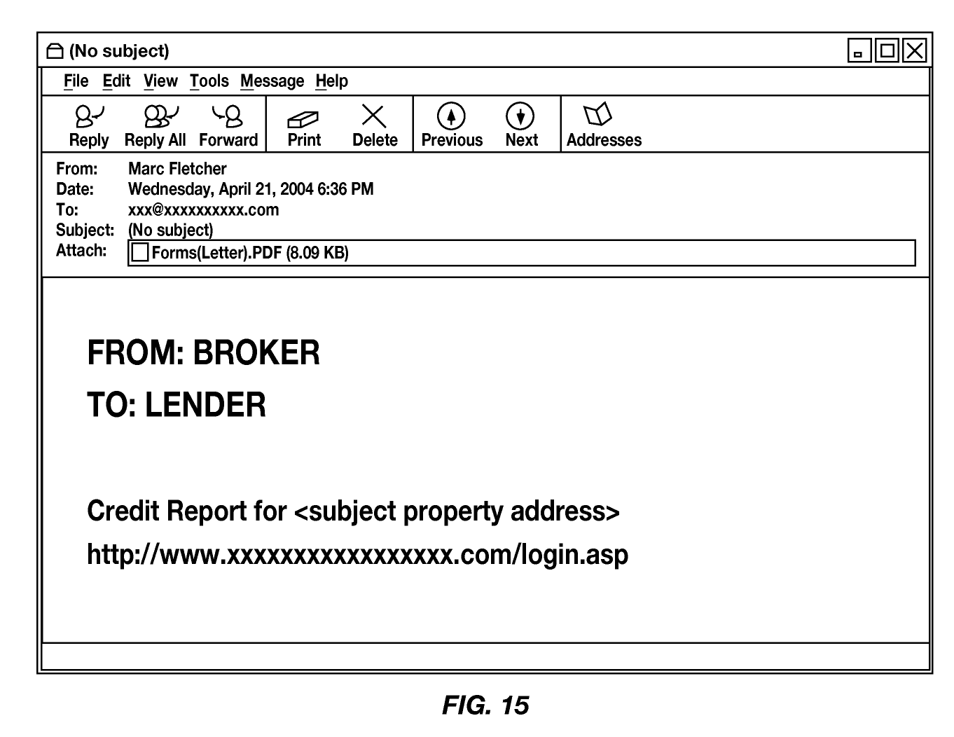

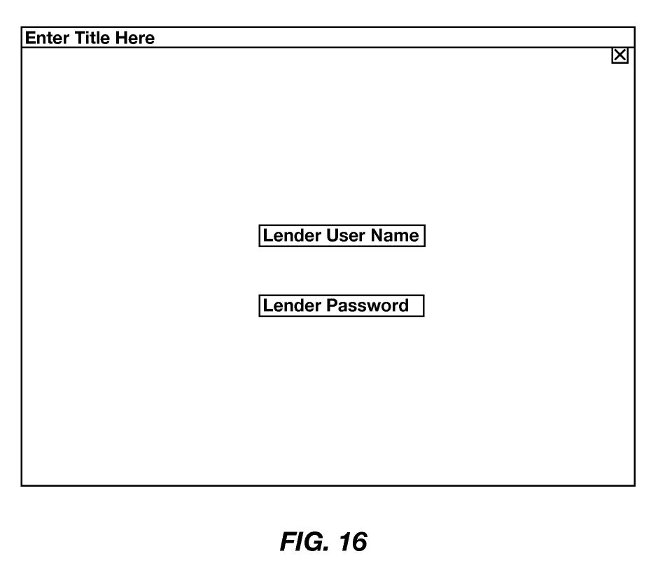

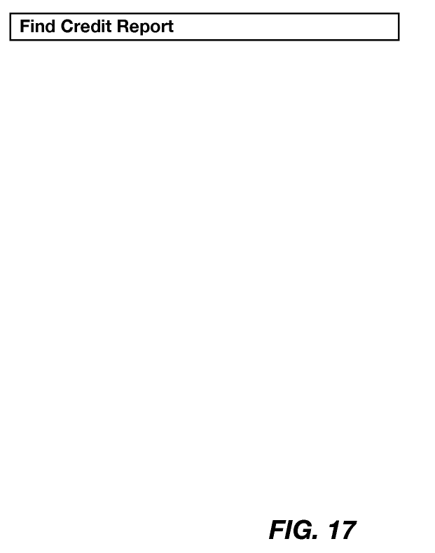

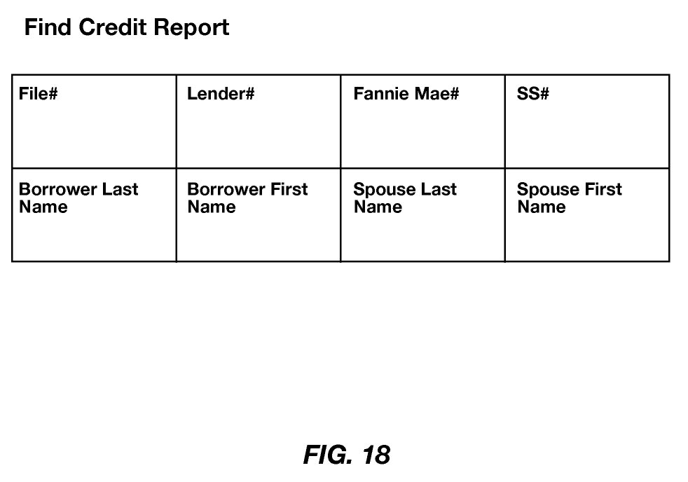

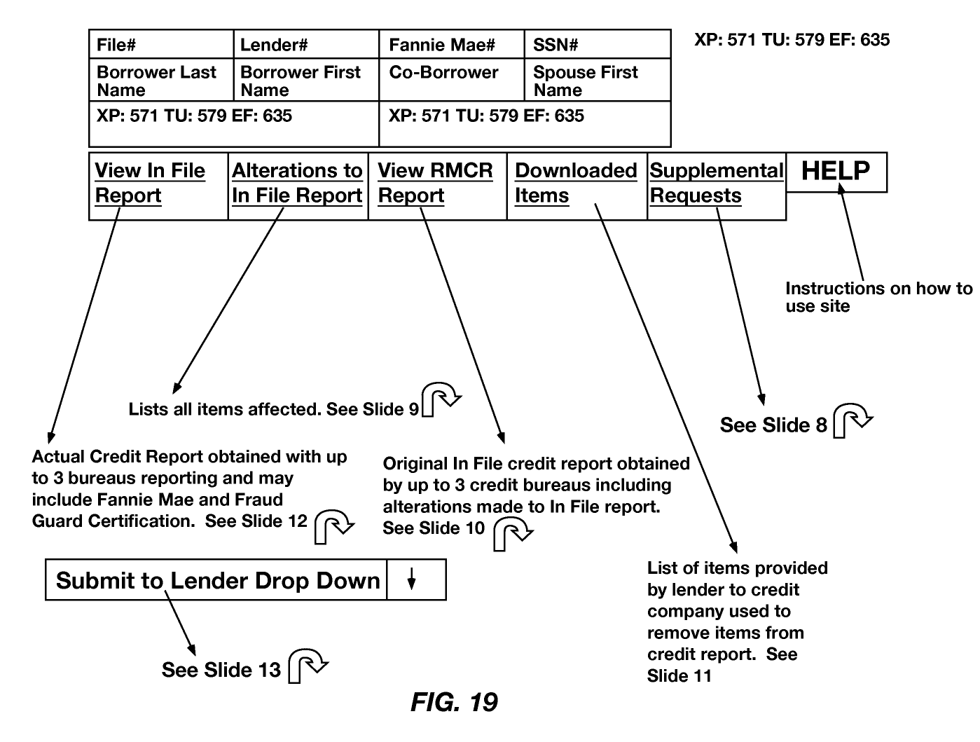

FIG. 15 illustrates a sample electronic notification. The broker may send a message to the lender. The message may include a link to the system website login screen. In this manner, all parties can access the information stored in the database 22. FIG. 16 illustrates a sample login page for allowing a lender into the system. FIG. 17 represents a link to a menu for finding a credit report. FIG. 18 illustrates a menu to search for a credit report of a particular borrower. FIG. 19 is a sample menu for a borrower and co-borrower. From this menu, the in file report may be viewed, the alterations to the in file report may be viewed, the RMCR may be viewed, downloaded items may be accessed, and supplemental requests may be viewed.

The Appraisal Module

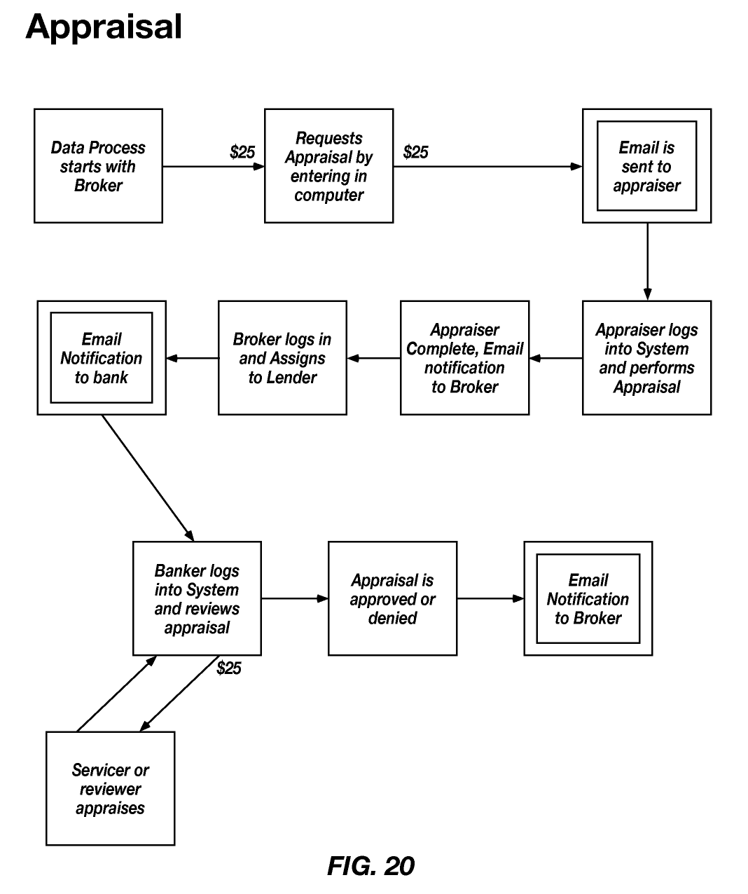

FIG. 20 illustrates an exemplary flow chart according to one embodiment of the present disclosure. The purpose of the appraisal module is to allow for easy appraisal requests as well as increasing the quality of the appraisal. The first step is for the broker to order the appraisal through the system. The system may have previously stored a list of pre-approved appraisers for the area in which the subject property resides. The system sends an electronic communication to the appraiser. The appraiser, once notified, logs into the system to accept or reject the appraisal. Once the appraisal has been completed, the appraiser uploads the appraisal into the system. The system preferably notifies the broker that the appraisal has been completed. The broker may then log into the system and assign the appraisal to a particular lender. The bank is also preferably notified through the system. The bank may then log into the system and analyzes the appraisal. If necessary, a review appraisal is conducted, which may be ordered through the system. Once the appraisal is approved, the broker is preferably notified through the system. In addition, fees may be exacted from the concerned parties at differing stages of information exchange, as is illustrated in FIG. 20 (which shows fees of $25.00). However, it is to be understood that there is no single amount or limit on the amount of fees which can be charged.

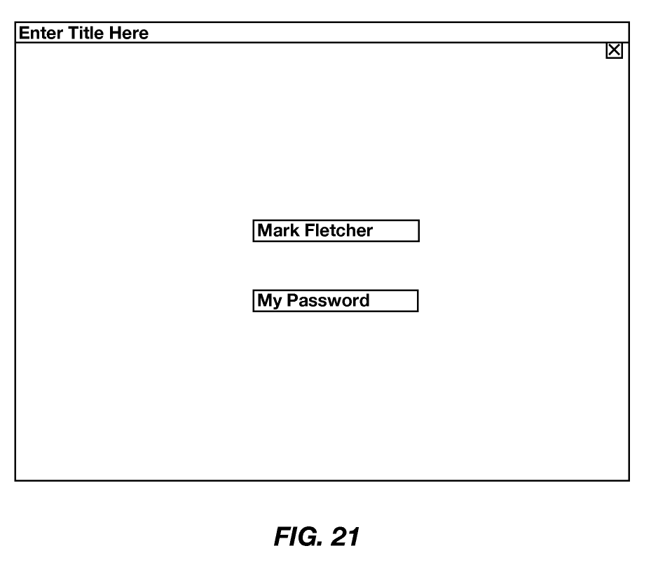

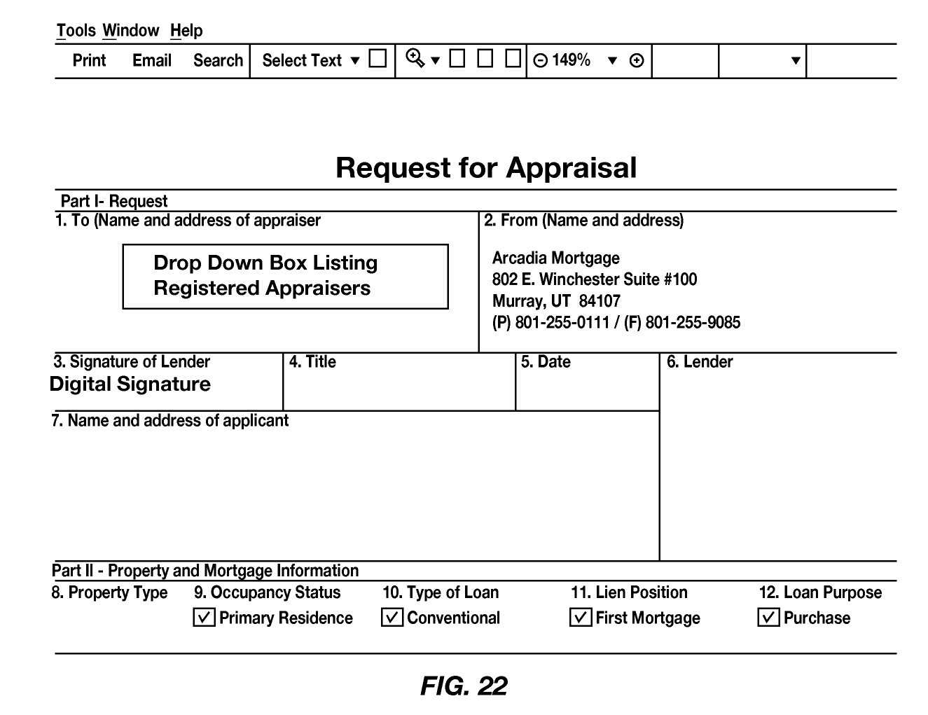

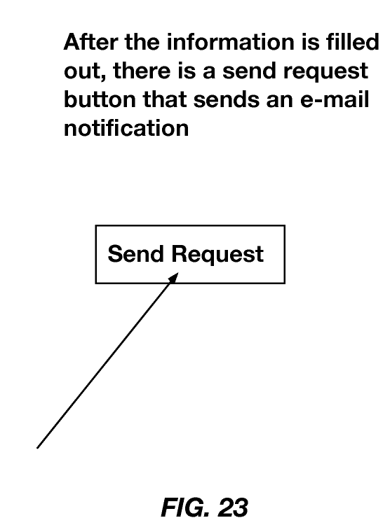

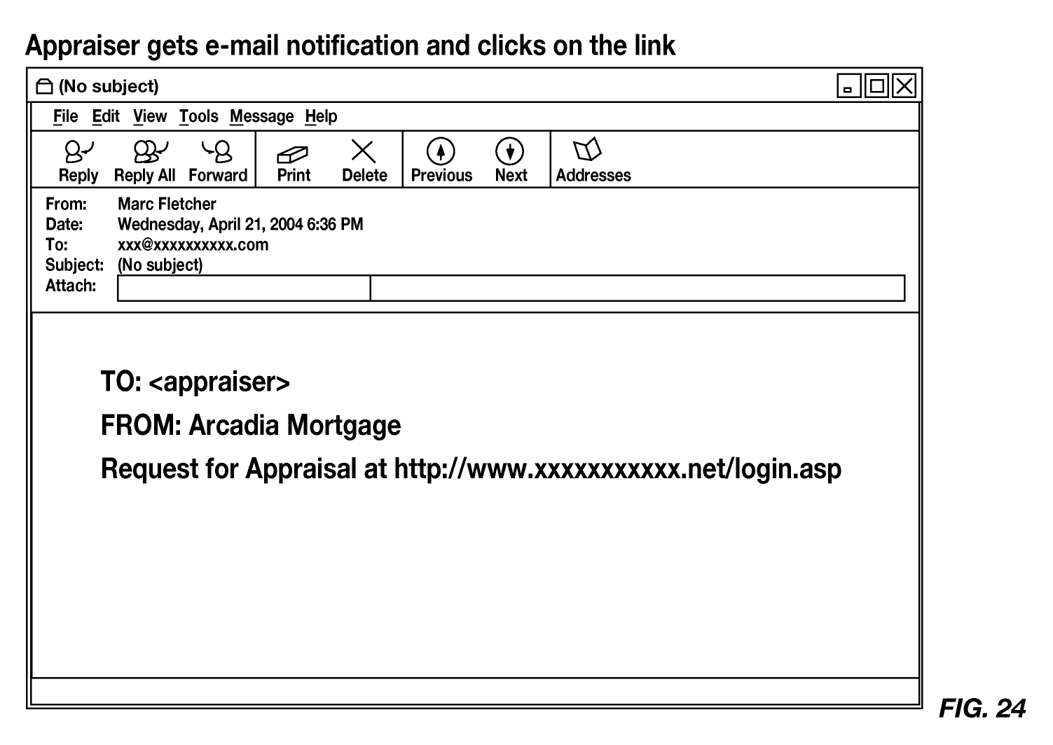

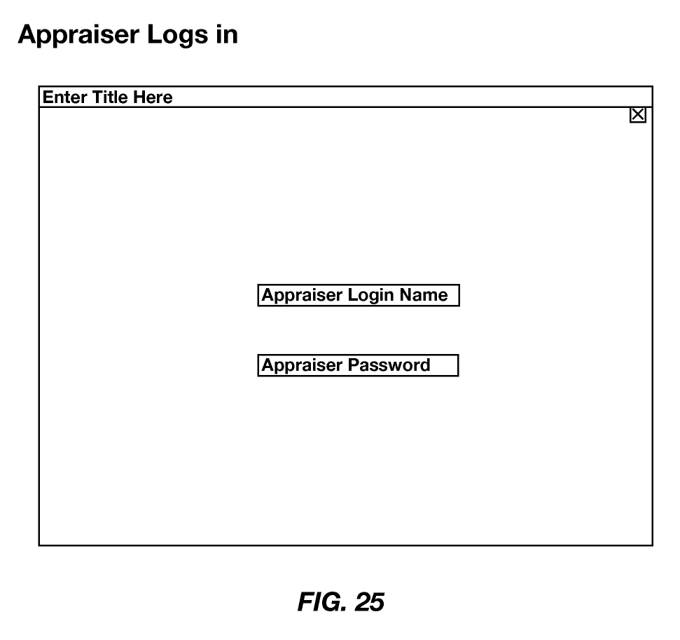

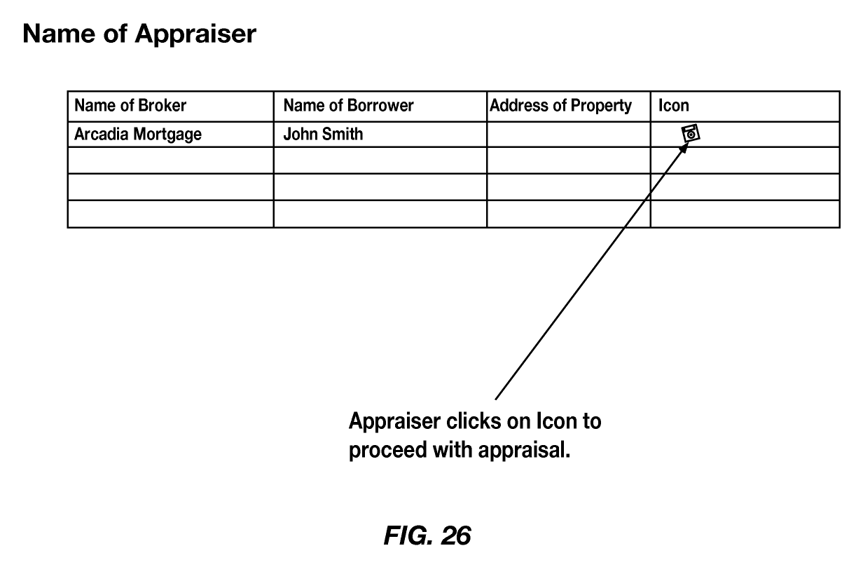

FIG. 21 shows an exemplary login screen for the broker requesting the appraiser. FIG. 22 illustrates a portion of a standard form which may be used to request the appraisal. The form may be completed online. Once the form is complete, the broker can send the appraisal as shown in FIG. 23. As shown in FIG. 24, the appraiser is preferably electronically notified of the request. The notification may simply include a link to the system. The appraiser, after clicking the link, is preferably taken to a login screen as shown in FIG. 25. Once logged in, the appraiser is presented with a menu showing the details of the request, including the name of the broker, name of the borrower, the address property and an “icon” to proceed to the appraisal request as shown in FIG. 26.

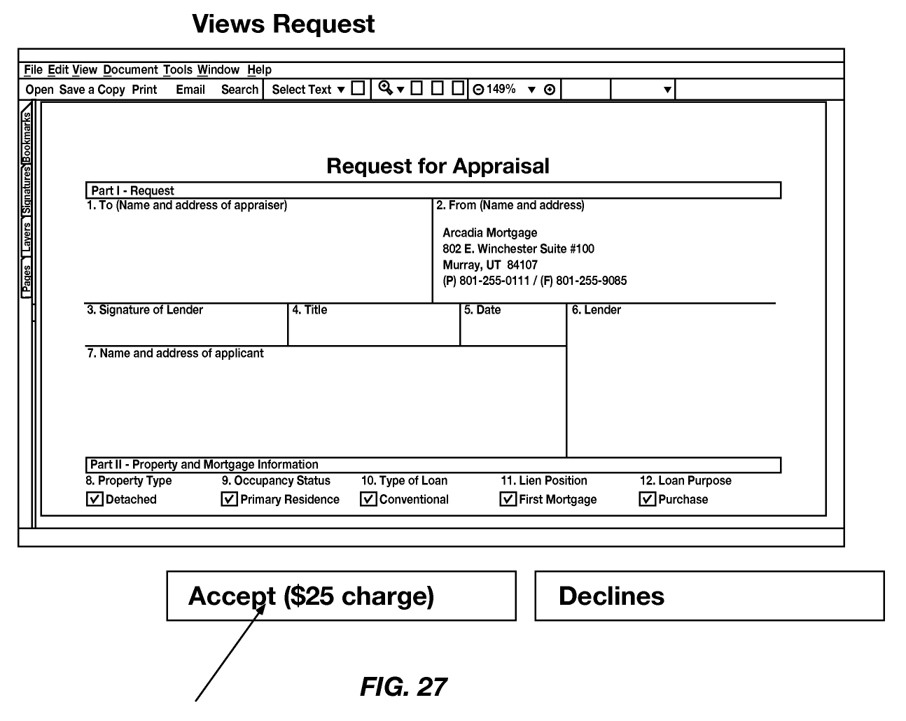

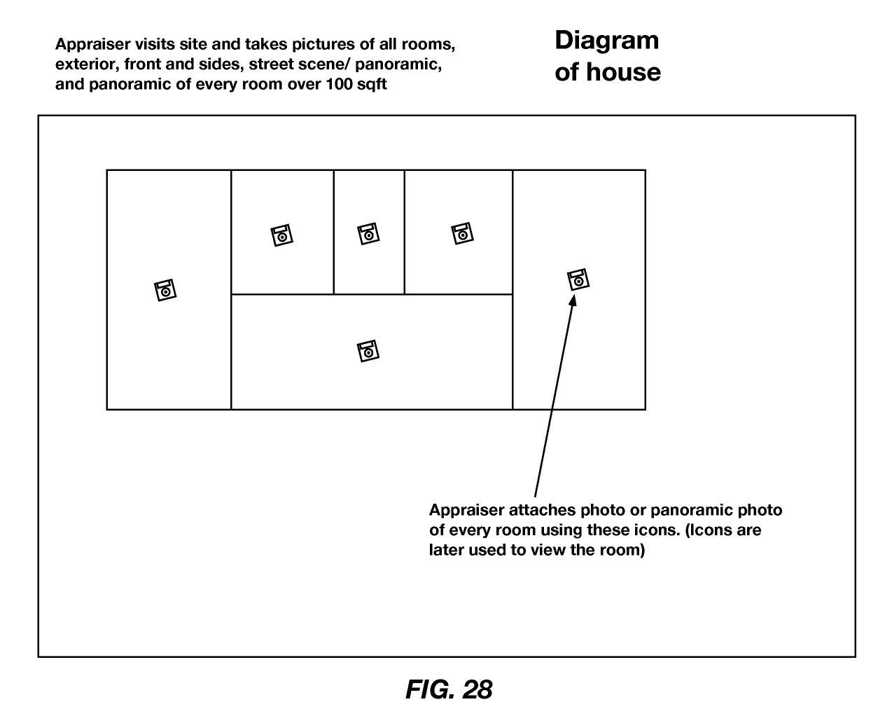

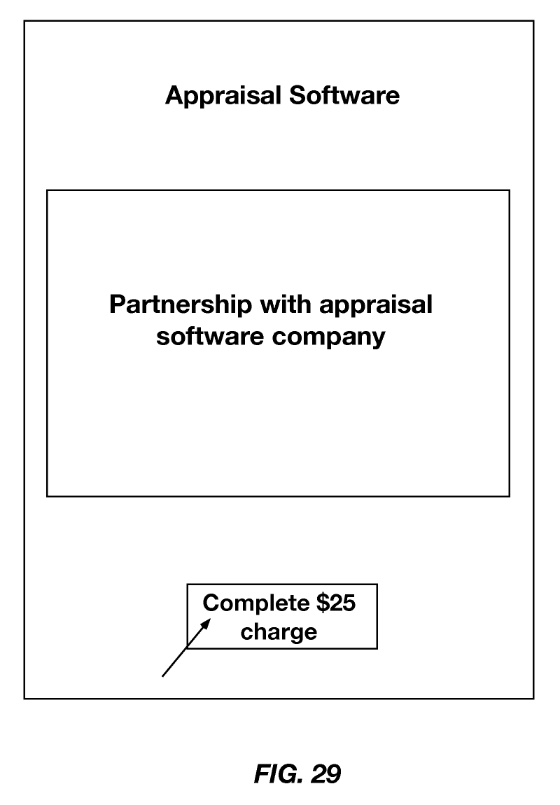

Upon clicking the icon, the request is displayed to the appraiser as shown in FIG. 27. If the appraiser accepts the request, the appraiser clicks the accept button and may be charged a nominal fee for the service. The appraiser may then conduct the appraisal of the property. After the appraisal, the appraiser can logon and input the information required by the system. For example, the appraiser is preferably required to make a diagram of the house and attach photos of each room as shown in one example embodiment in FIG. 28. The appraiser may also complete the standard appraisal through appraisal software as shown in FIG. 29.

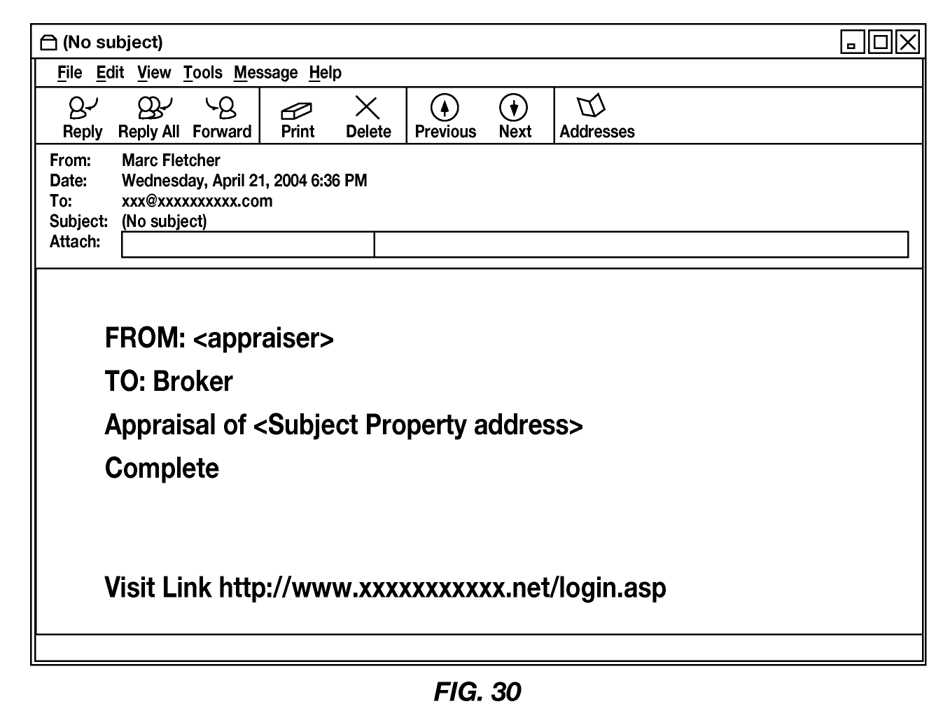

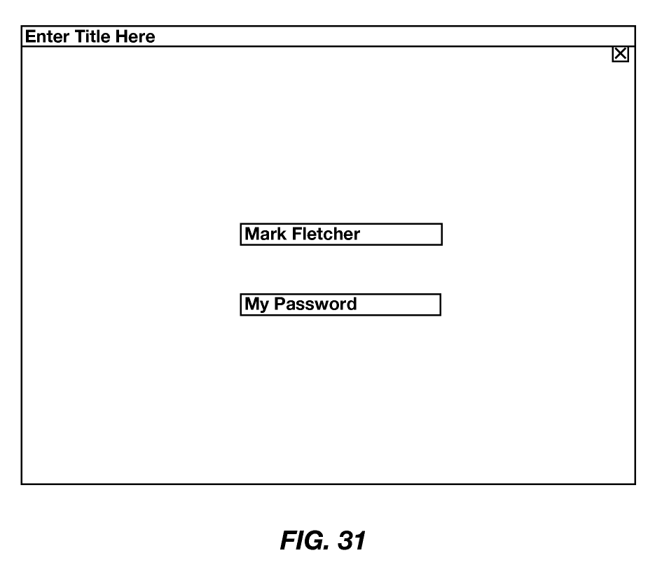

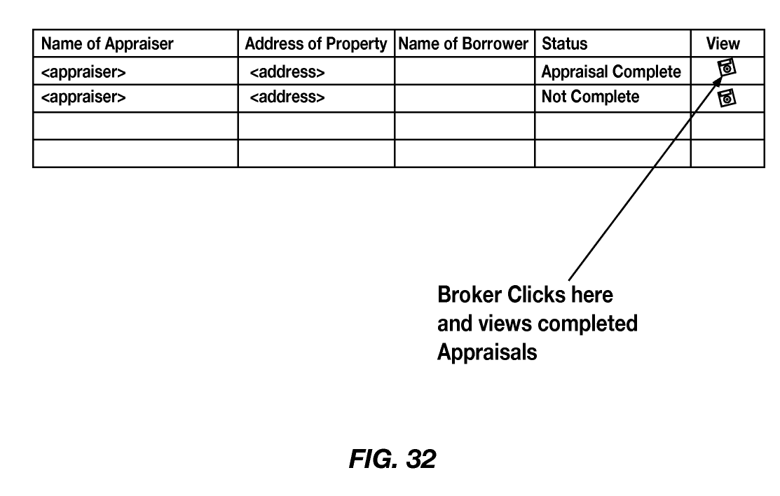

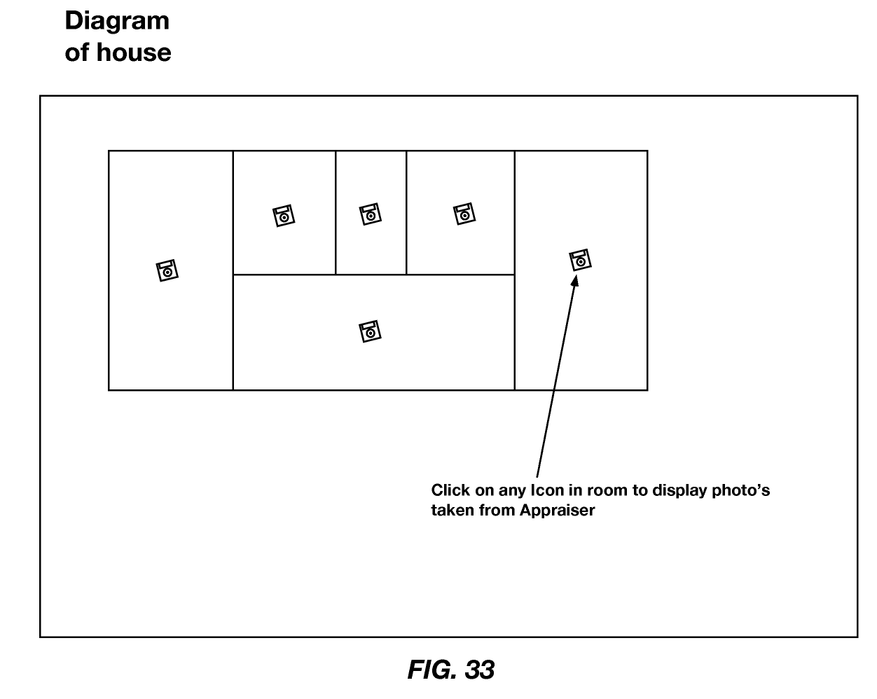

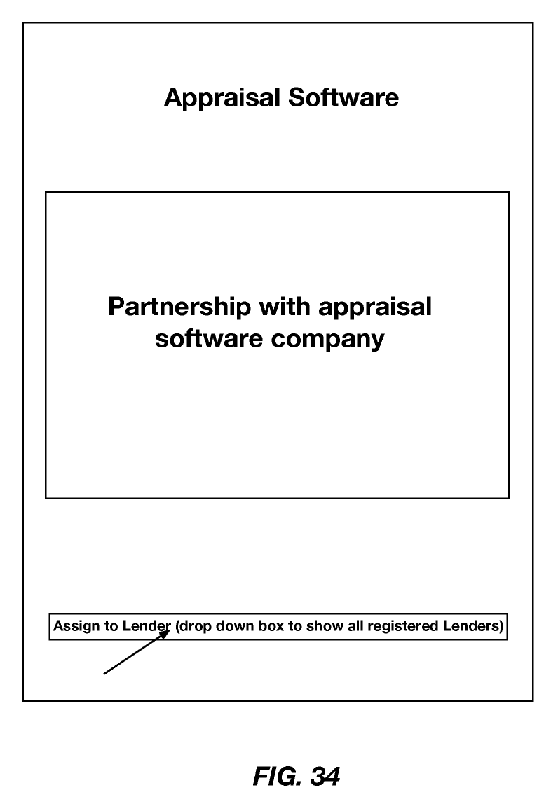

As shown in FIG. 30, once the appraisal is complete, the broker may be notified by the system via an electronic message. Again, the broker may click a link to a login screen as shown in FIG. 31. Once logged in, the broker may be presented with a menu to select and view the recently completed appraisal as shown in FIG. 32. The broker may also view the diagram of the property as well as view the photos of the rooms as shown in FIG. 33. The broker may also view the appraisal and assign the appraisal to a lender as shown in FIG. 34.

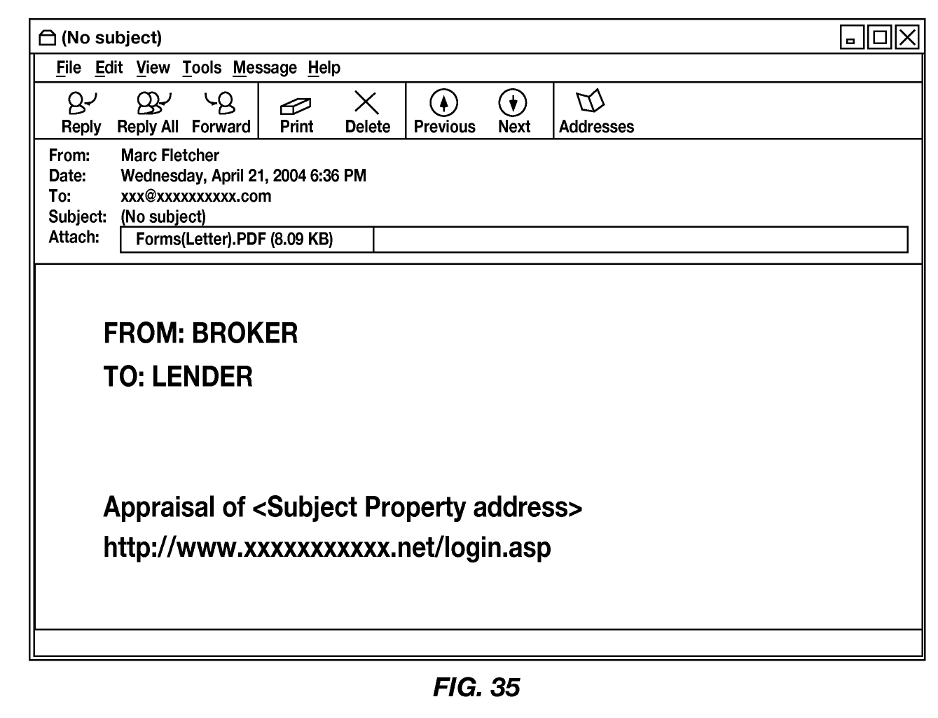

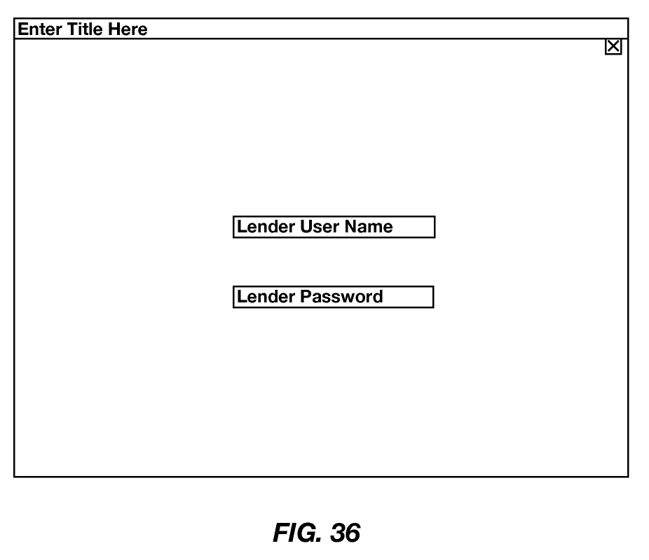

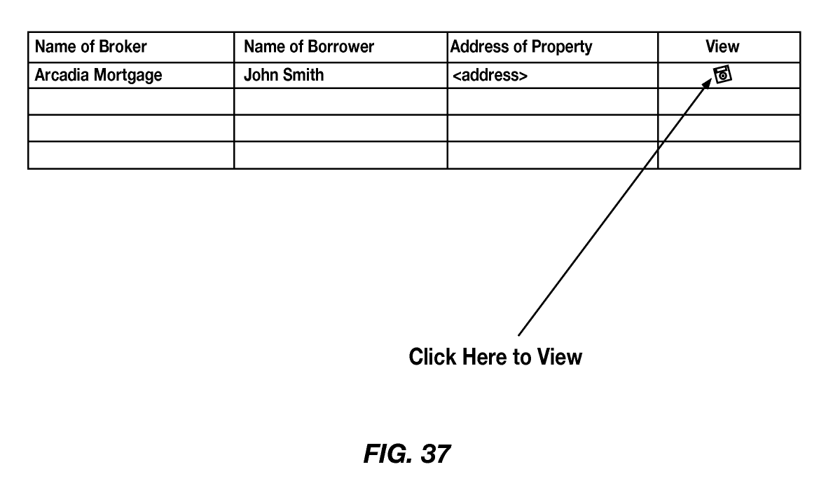

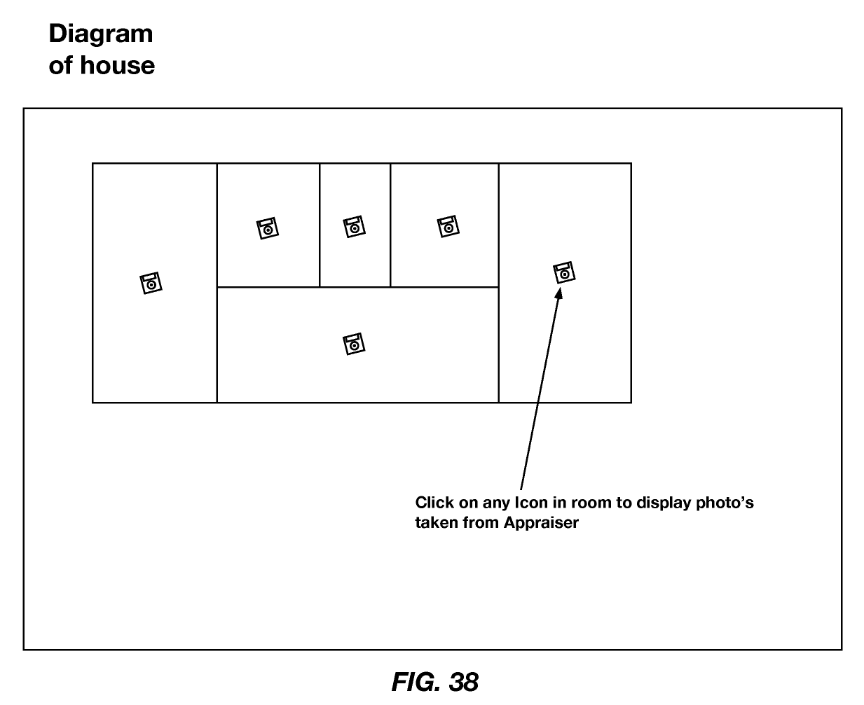

As shown in FIG. 35, the system preferably notifies the lender that the appraisal has been completed via an electronic message. Again, a link can be provided for easy system access to the login screen shown in FIG. 36. Once logged in, the system provides a menu to the lender to allow viewing of the appraisal as shown in FIG. 37. Again, the lender may be shown a diagram of the property as well as view the photos of the individual rooms as shown in FIG. 38.

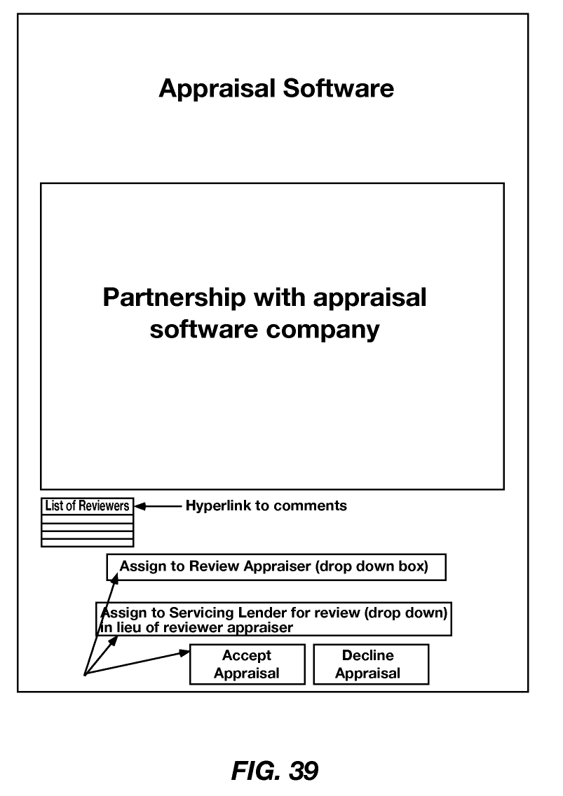

FIG. 39 illustrates the actions that a lender may take with the appraisal. Where necessary, the lender may assign a review appraiser to conduct a review of the appraisal and/or property. The lender may also assign the appraisal to a servicing lender for review. The lender may also accept the appraisal or decline the appraisal according to its lending guidelines. A hyper-link may also provide access to comments made by reviewers.

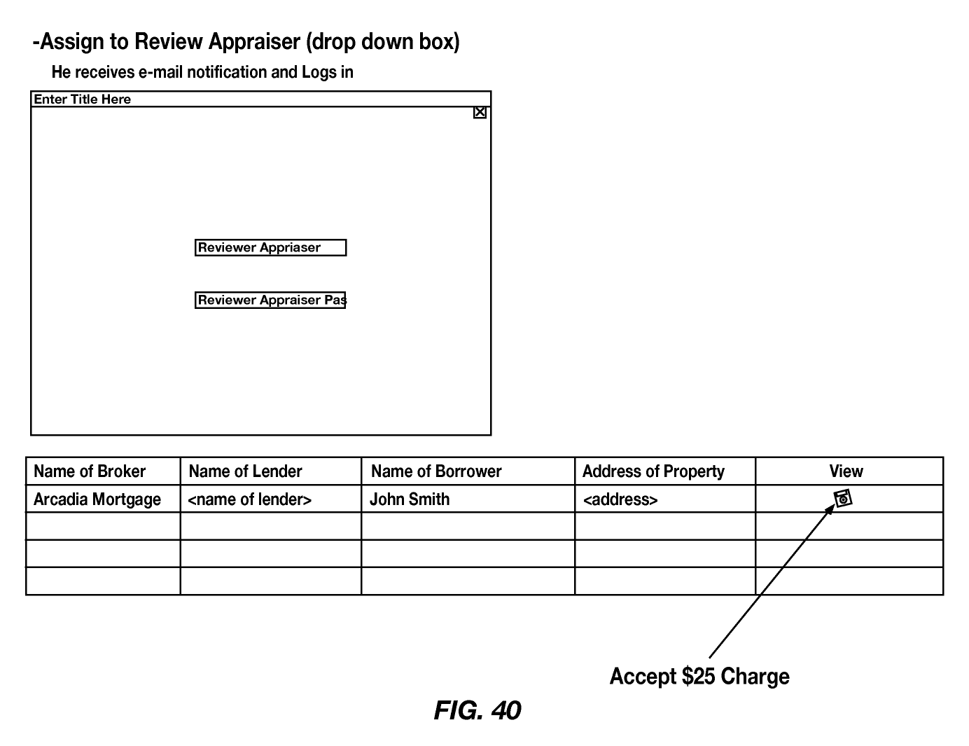

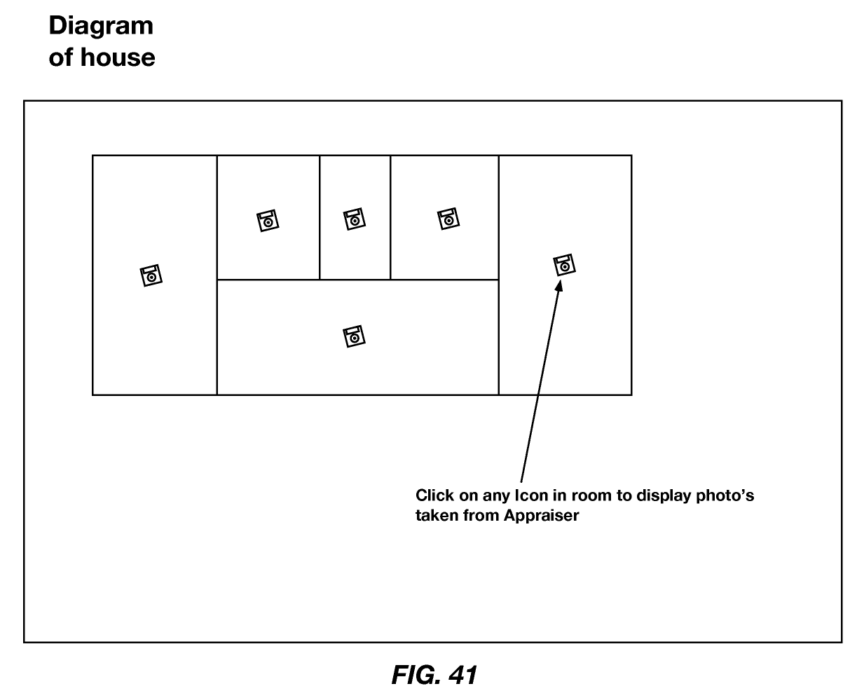

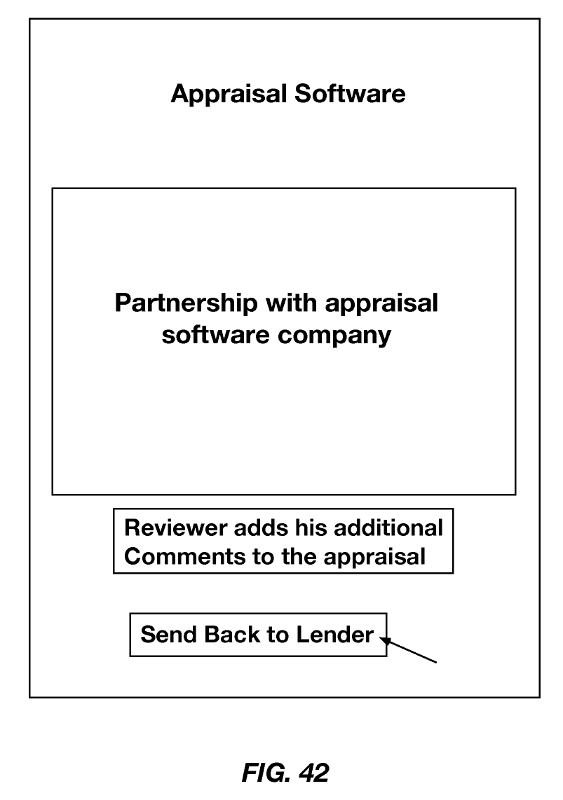

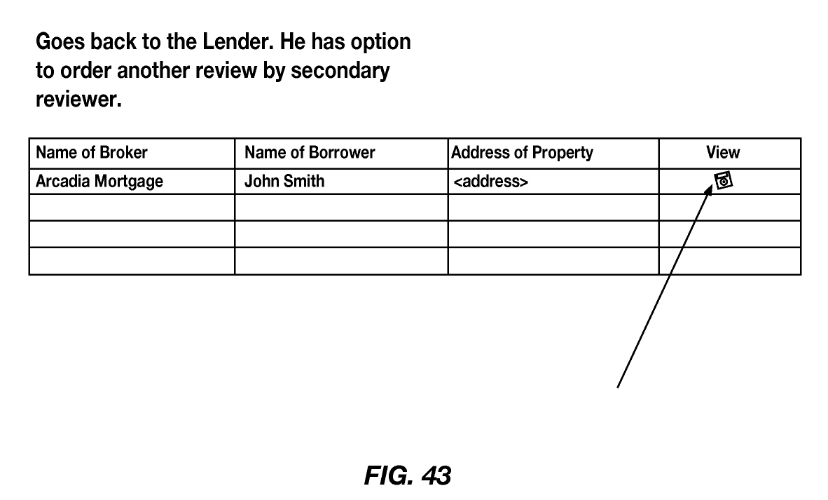

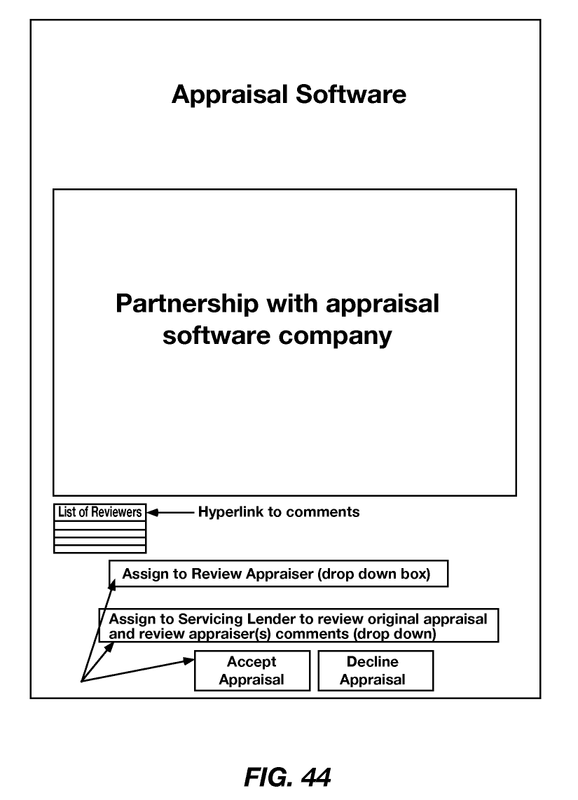

FIG. 40 illustrates a menu to allow the lender to assign a review appraiser. Again, the review appraiser preferably receives an email notification of the request and is linked to a login screen. The review appraiser may accept the request for a small fee. FIG. 41 is an illustration of a diagram of the property that may be accessed by the review appraiser. As shown in FIG. 42, the system can allow the review appraiser to add additional comments regarding the appraisal and send the information back to the lender via the system. The lender may then accept the reviewer's comments or order another review as shown in FIGS. 43 and 44.

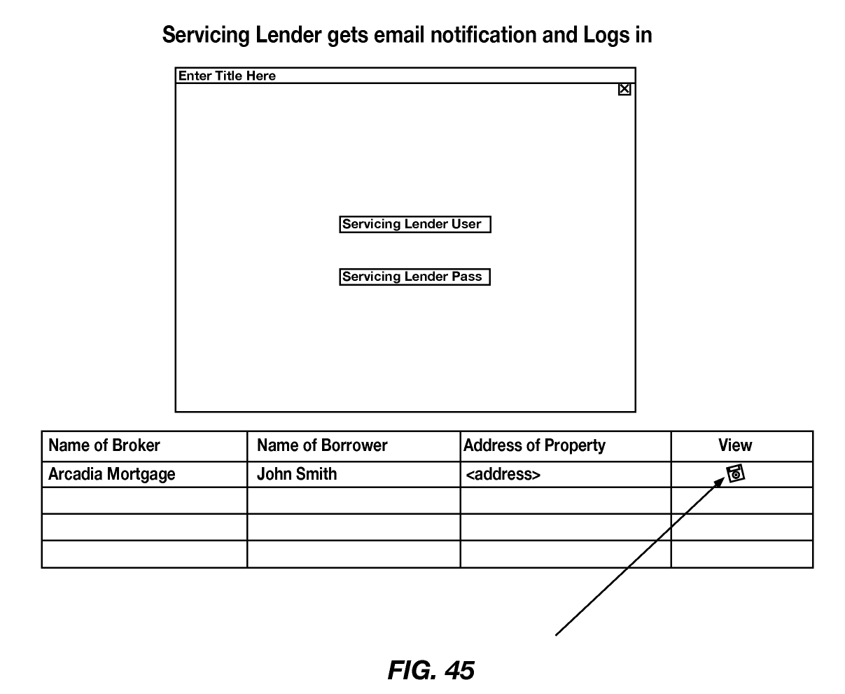

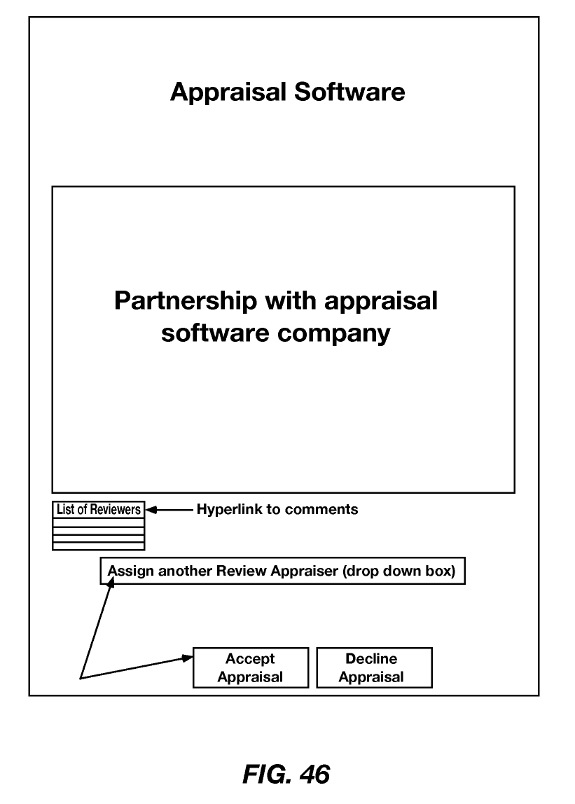

If the lender assigns the appraisal to a servicing lender, the servicing lender receives an electronic notification as previously described and logs into the system. As shown in FIGS. 45 and 46, the servicing lender may review the appraisal in the same manner as the lender.

The Title Module

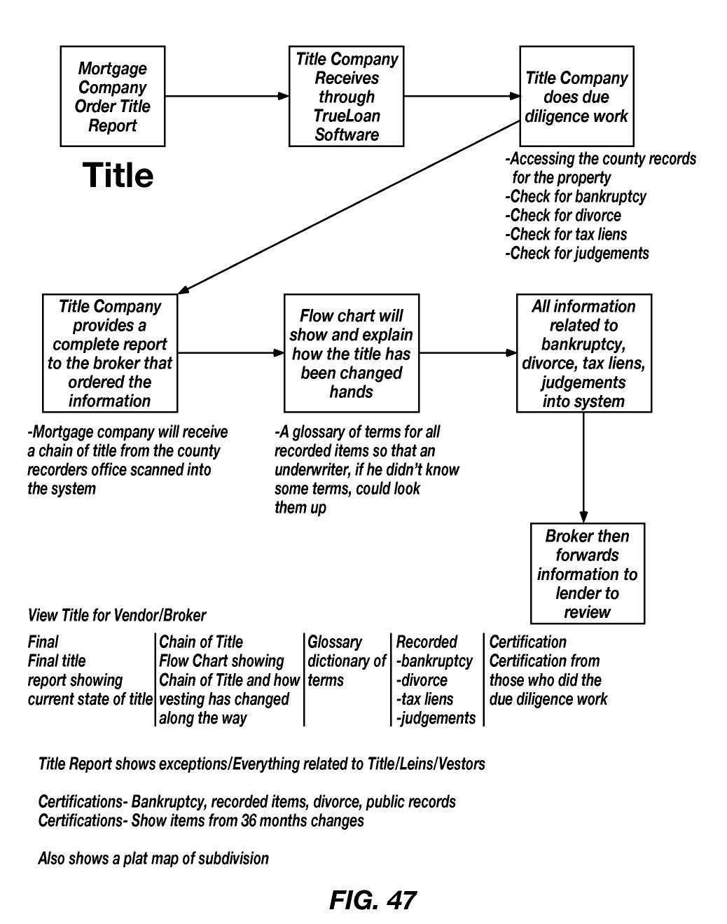

The purpose of the title module is to allow greater facilitation between the lender, broker and title company in the title process. The first step is for the mortgage company to order the title report through the system. The title company preferably receives the request through the system via electronic communication as previously described. The title company can accept the request and complete the title work. The title company can then provide the necessary information to the mortgage company by entering the information into the system. A flow chart generated by the system using the information provided by the title company is preferably displayed. All related information regarding bankruptcy, divorce, tax liens, judgments are preferably entered into the system as well. The broker and lender may access this information through the system. The above steps are all shown in FIG. 47.

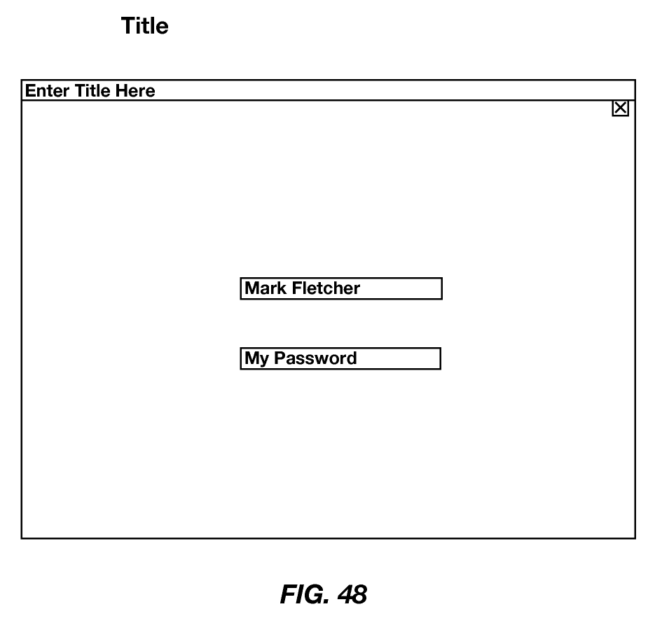

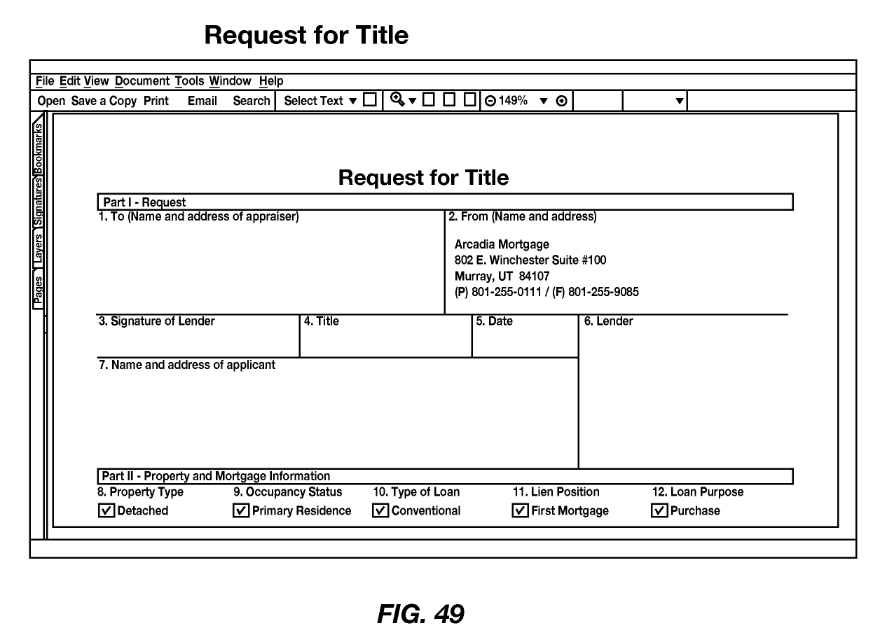

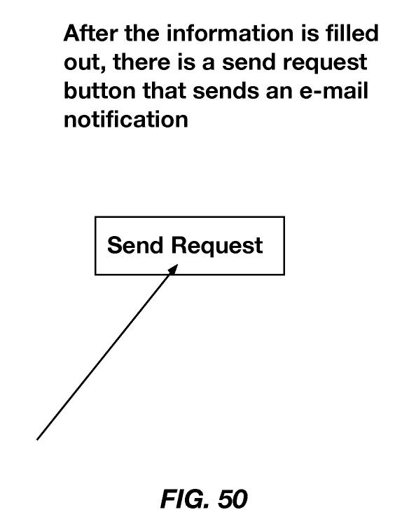

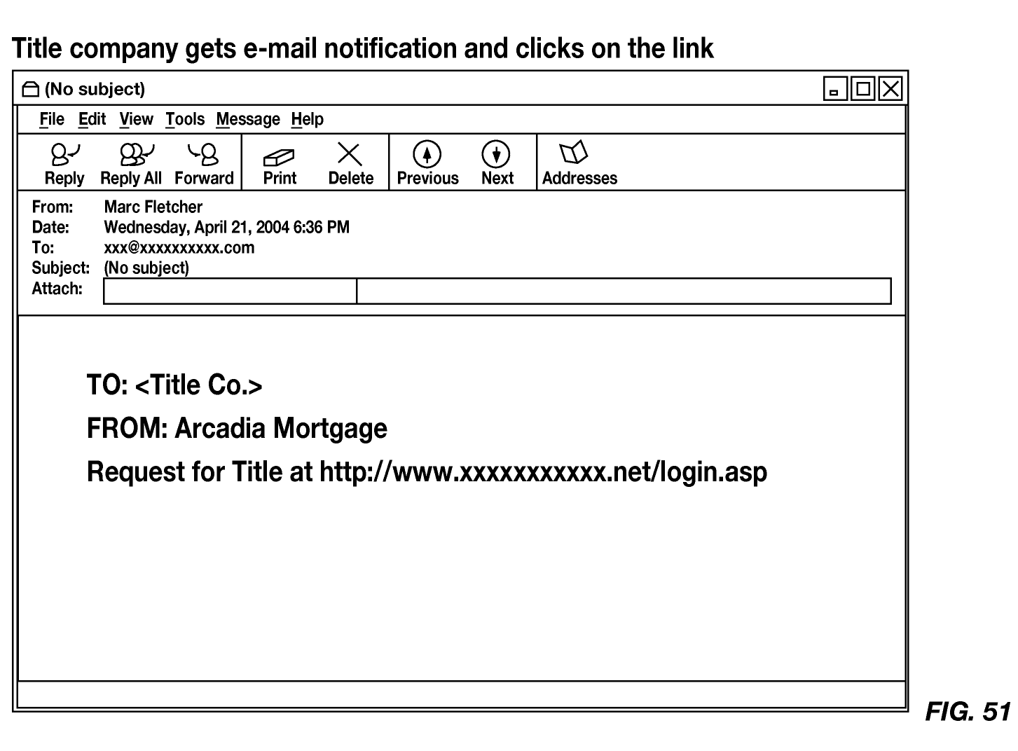

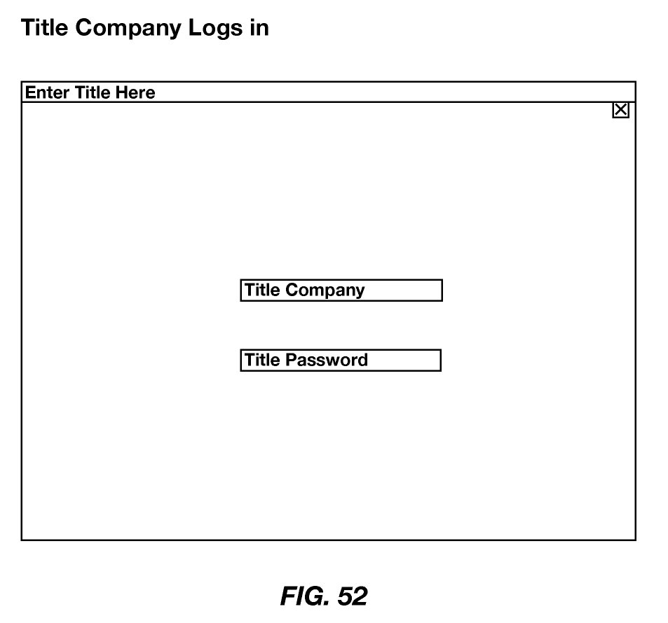

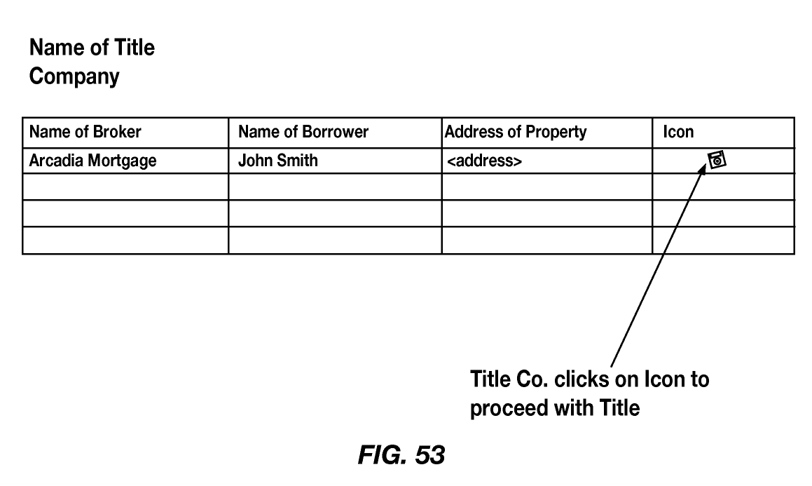

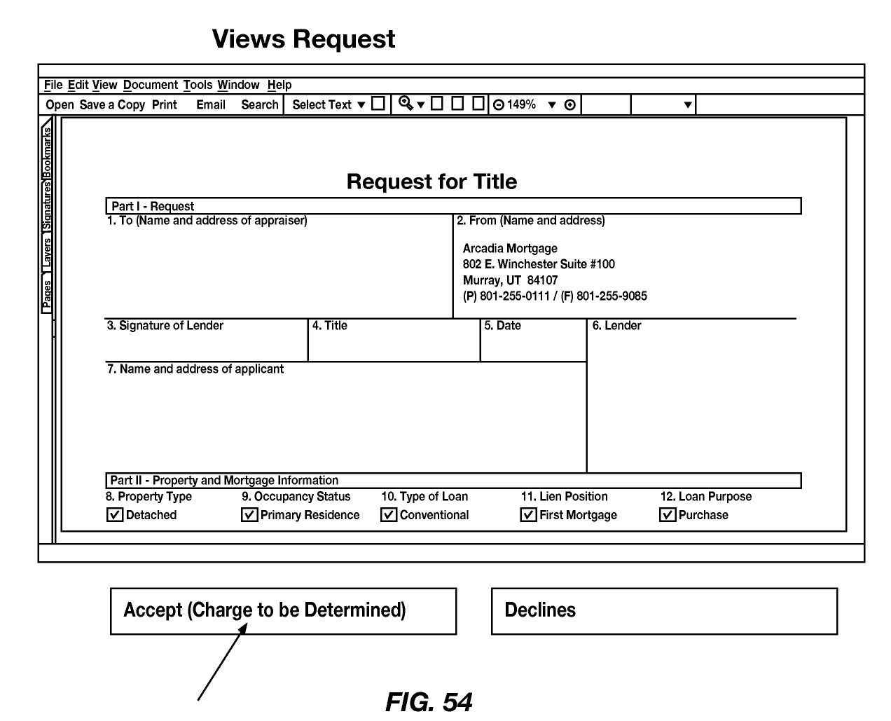

FIG. 48 illustrates an exemplary login screen to access the title module. FIG. 49 illustrates a request for title that may be completed online by the mortgage company. Once the form is completed, the mortgage company may send the request via the system as shown in FIG. 50. FIG. 51 illustrates an electronic notification to the title company as previously described. The title company may then login to the system as shown in FIG. 52. The title company is presented with a menu to select and view the request for title as shown in FIG. 53. The title company may then accept or decline the request to perform the title search as shown in FIG. 54 through the system.

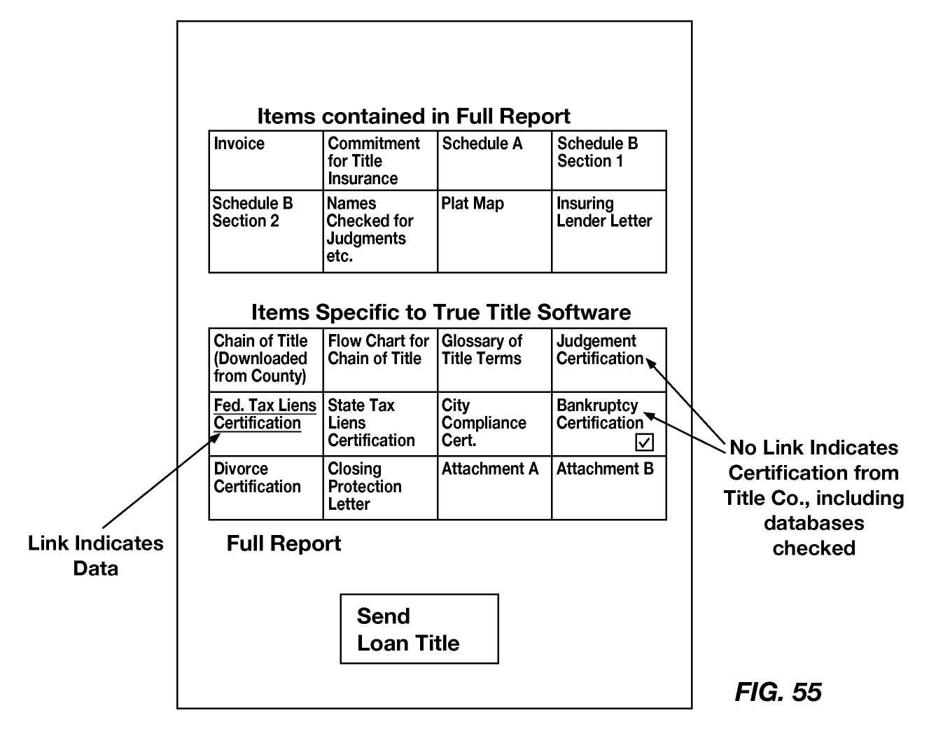

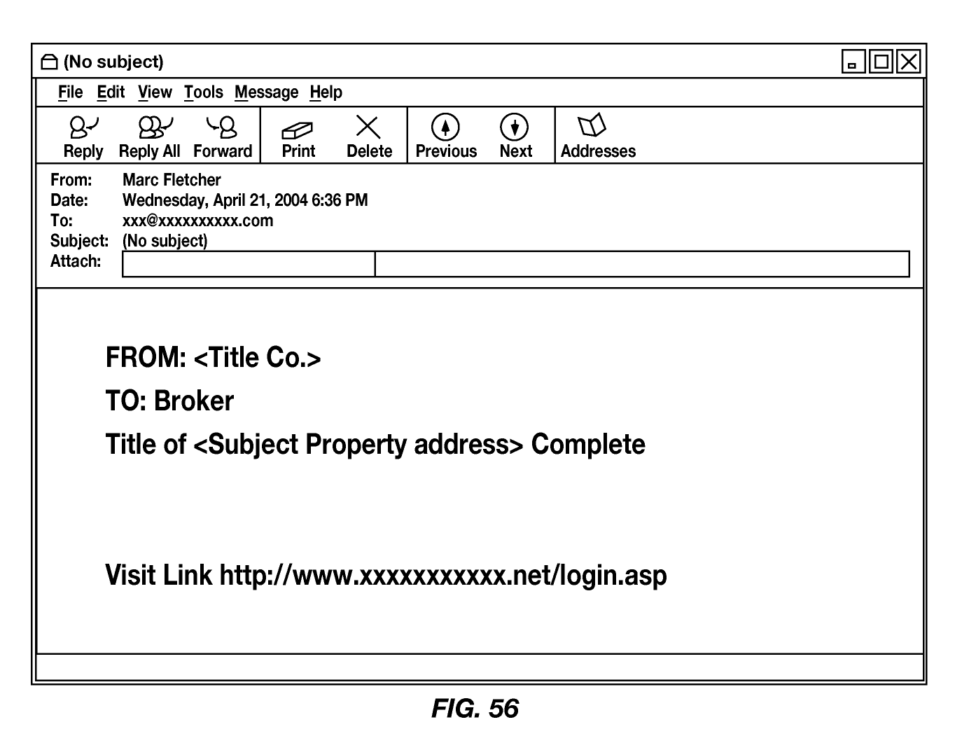

FIG. 55 illustrates one embodiment of the various components of the title report that may be required by the system. It will be appreciated that this is more information than is included in a “standard” title report. The full report may contain such information as an invoice, commitment for title insurance, Schedule A, Schedule B (section 1 and 2), names checked for judgments, plat map and insuring lender. Items specific to the system may include chain of title, flow chart for chain of title, glossary of title terms, judgment certification, federal tax lien certification, state tax liens certification, city compliance certification, bankruptcy certification, divorce certification, closing protection letter, and attachments A and B. When this information has been completed and stored on the database 22, the system preferably sends the broker an electronic notification that it has been completed as shown in FIG. 56.

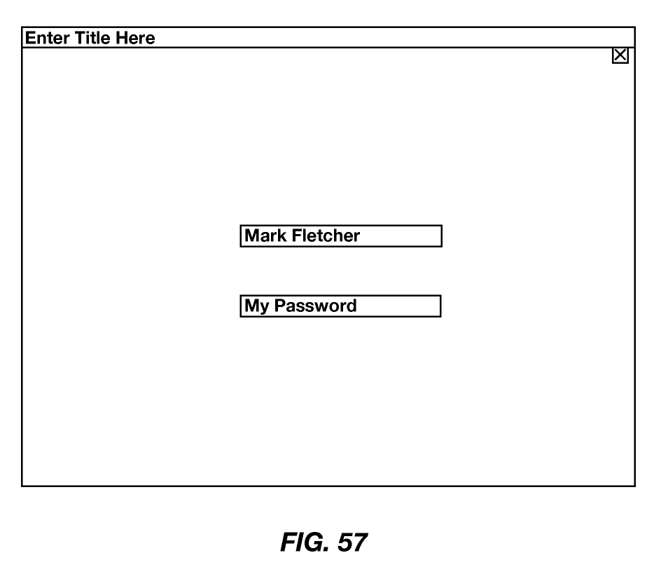

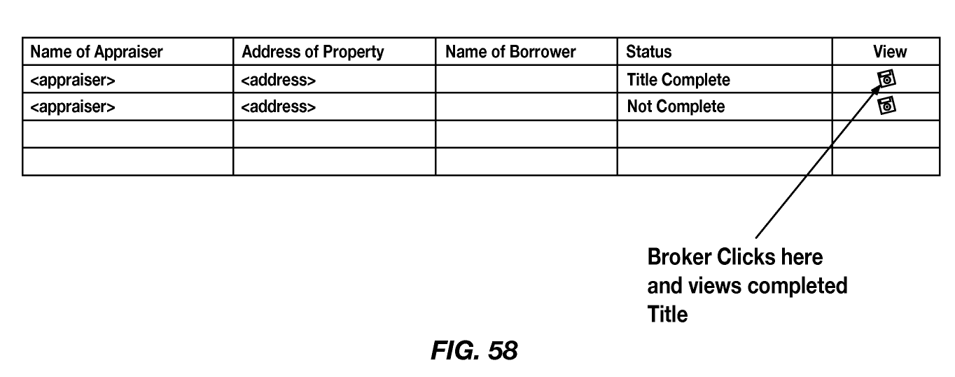

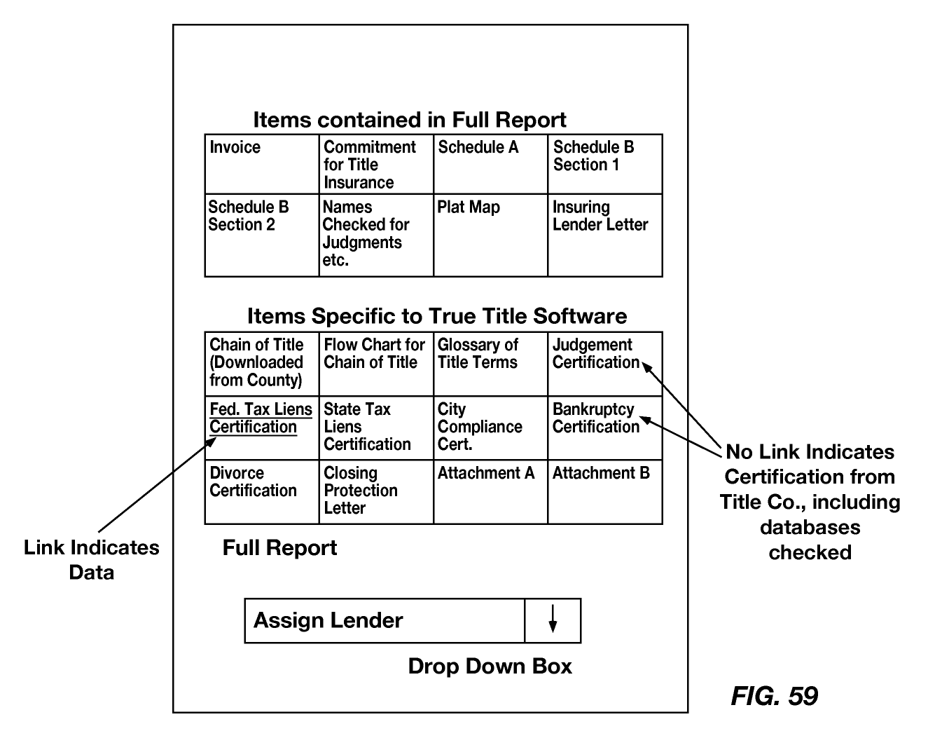

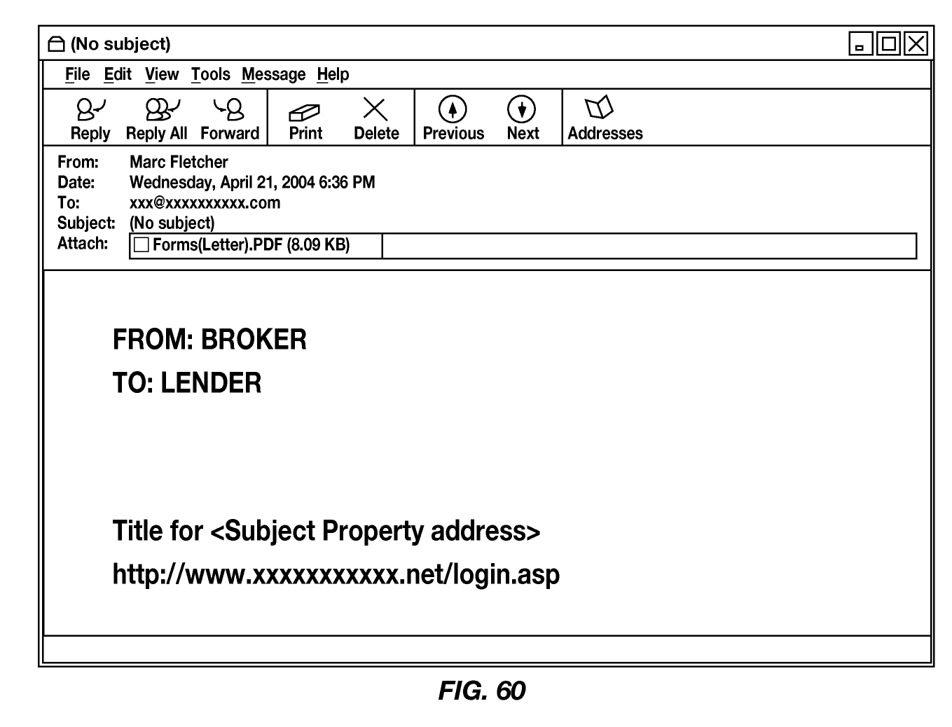

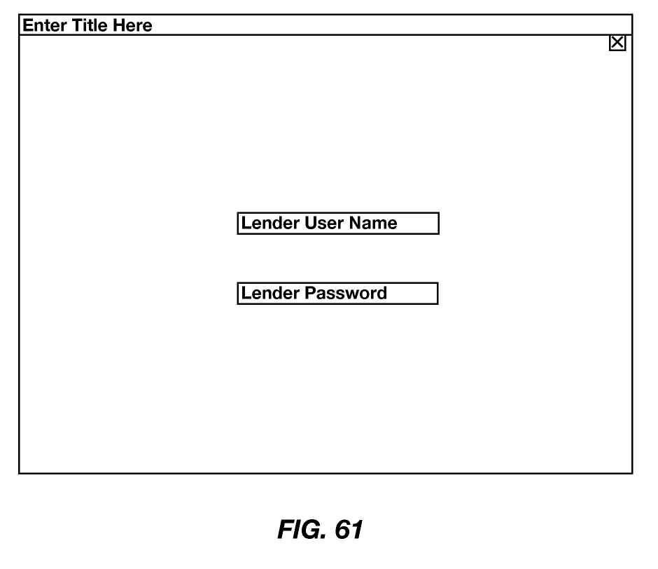

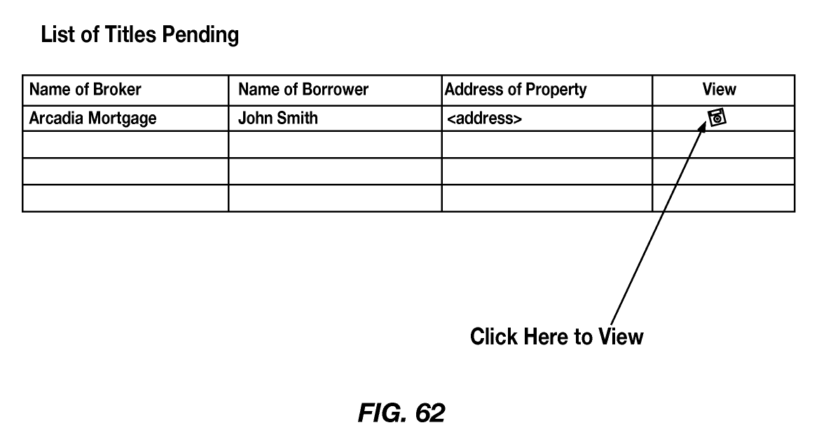

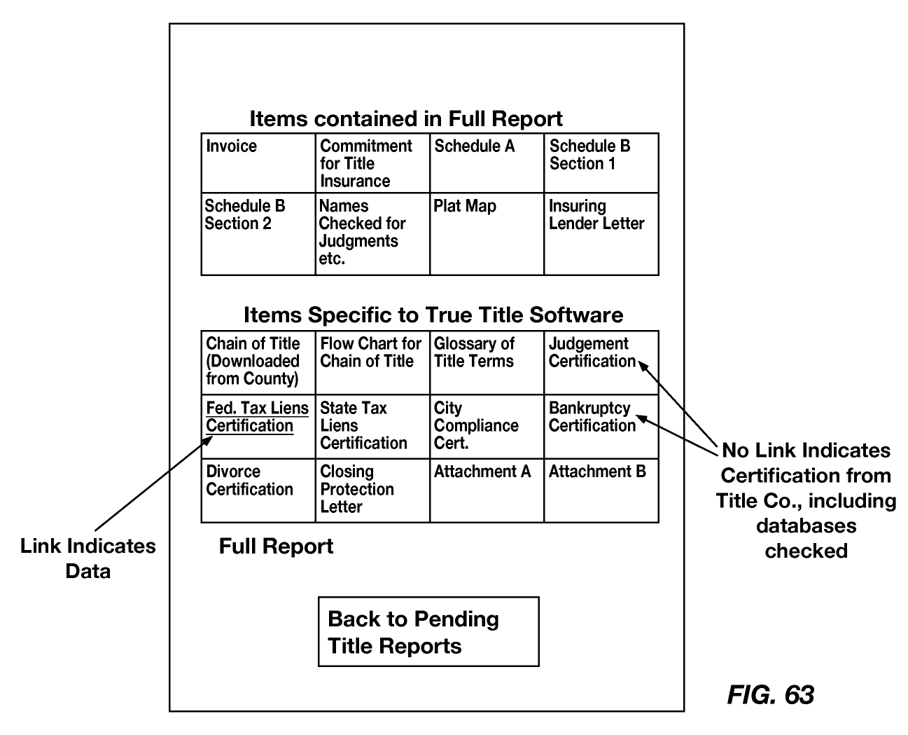

As shown in FIG. 57, the broker may access the system and view the information as illustrated in FIG. 58. The broker is presented with a menu similar to that of the title company, as shown in FIG. 59. The broker may review the information on the title report, and once satisfied, assign the title report to the lender as shown in FIG. 59. Once the title has been assigned, the lender can be notified by the system via an electronic communication as shown in FIG. 60. As shown in FIG. 61, the lender may log into the system. FIG. 62 is a menu allowing the lender to select the appropriate title report from a list of pending title reports. FIG. 63 is a screen shot similar to that shown in FIG. 59 and allows the lender to review and approve all aspects of the title report pursuant to the lenders guidelines.

It will be appreciated that the various modules described above allow for a centralized repository for the information and documents needed to complete a financial transaction. The centralized nature of the present system eliminates the need for the transfer of actual documents between the various entities involved in a financial transaction. Moreover, the present invention simplifies and automates actions previously necessary to carry out manually. For example, the assignment of the appraisal and title reports may be carried out electronically. In addition, the tracking of changes to the credit report and supporting documentation may be stored centrally in the database 22.

Another aspect of the present invention may allow the loan applicant, i.e. borrower, to access the system to obtain status reports regarding the progress of the loan.

It will be appreciated that the structure and apparatus disclosed herein is merely one example of a means for a system and method of producing a real estate loan transaction, and it should be appreciated that any structure, apparatus or system for producing a real estate loan transaction which performs functions the same as, or equivalent to, those disclosed herein are intended to fall within the scope of a means for producing a real estate loan transaction, including those structures, apparatus or systems for producing a real estate loan transaction which are presently known, or which may become available in the future. Anything which functions the same as, or equivalently to, a means for producing a real estate loan transaction as described herein falls within the scope of this element.

Those having ordinary skill in the relevant art will appreciate the advantages provided by the features of the present disclosure. For example, it is a feature of the present disclosure to provide a centralized repository for information and documents necessary to complete a real estate loan transaction. Another feature of the present disclosure is to provide such a centralized repository with network access for allowing remote access to said repository. It is a further feature of the present disclosure, in accordance with one aspect thereof, to provide a system for notifying the various participants that a particular event has occurred.

In the foregoing Detailed Description, various features of the present disclosure are grouped together in a single embodiment for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description by this reference, with each claim standing on its own as a separate embodiment of the present disclosure.

It is to be understood that the above-described arrangements are only illustrative of the application of the principles of the present disclosure. Numerous modifications and alternative arrangements may be devised by those skilled in the art without departing from the spirit and scope of the present disclosure and the appended claims are intended to cover such modifications and arrangements. Thus, while the present disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

What is claimed is:

1. A system for facilitating the completion of a financial transaction, said system comprising:
a database;
a central processing means in communication with said database, said central processing means having computer code running thereon operable to:
(a) allow loan application data, credit data, appraisal data, and title data to be stored in the database and retrieved from the database;
(b) allow electronic assignment of the appraisal and title data;
(c) allow electronic notification regarding completion of any of the loan application data, credit data, appraisal data and title data;
(d) serve web pages upon request to remote computer terminals over a network; and
(e) track changes to any of said loan application data, credit data, appraisal data and title data.

2. The system of claim 1, wherein said central processing means further comprises computer code running thereon operable to upload the appraisal data in a pre-specified format.

3. The system of claim 1, wherein said central processing means further comprises computer code running thereon operable to allow selective access to the loan application data, credit data, appraisal data, and title data.

4. The system of claim 1, wherein said central processing means further comprises computer code running thereon operable to retrieve the credit data from a credit agency over a network.

5. The system of claim 6, wherein said central processing means further comprises computer code running thereon operable to request a review of an account on the credit report from the credit agency.

6. The system of claim 1, wherein said central processing means further comprises computer code running thereon operable to request an appraisal from an appraiser.

7. The system of claim 6, wherein said central processing means further comprises computer code running thereon operable to assess a charge to the appraiser for accepting said request for an appraisal.

8. The system of claim 1, wherein said central processing means further comprises computer code running thereon operable to request an independent review of the appraisal data stored in the database.

9. The system of claim 6, wherein said central processing means further comprises computer code running thereon operable to automatically notify the appraiser of the order for an appraisal.

10. The system of claim 1, wherein said central processing means further comprises computer code running thereon operable to request a title report from a title company.

11. The system of claim 10, wherein said central processing means further comprises computer code running thereon operable to assess a charge to the title company for accepting said request for a title report.

12. The system of claim 11, wherein said central processing means further comprises computer code running thereon operable to automatically notify the title company of the request for a title report.

13. The system of claim 1, wherein said central processing means further comprises computer code running thereon operable to display a chain of title based upon the title data.

14. The system of claim 1, wherein said central processing means further comprises computer code running thereon operable to display a glossary of title terms.

15. The system of claim 1, wherein the network is the World Wide Web.

16. A method of processing information used in a financial transaction, said method comprising the steps of:
(a) receiving and storing a first credit report for a borrower in an electronic database from a credit agency;
(b) receiving an updated credit report for the borrower from the credit agency;
(c) tracking changes between the first credit report and the updated credit report; and
(d) generating upon request a visual display indicating changes between the first credit report and the updated credit report.

17. The method of claim 16 further comprising the step of storing supporting documentation for any changes between the first credit report and the updated credit report in the electronic database.

18. The method of claim 17 further comprising the step of displaying the supporting documentation in response to a request.

19. The method of claim 18 wherein the supporting documentation is stored in PDF format.

20. The method of claim 16 further comprising the step of receiving a request to order the first credit report from a loan officer.

21. The method of claim 20 further comprising the step of receiving the request electronically.

22. A method of processing information used in a financial transaction, said method comprising the steps of:
(a) receiving a request to order a title report for real property from a requestor;
(b) generating an electronic notification of the request to a title company;
(c) receiving an acceptance from the title company to the request;
(d) receiving and storing in an electronic database the title report; and
(e) receiving a request to assign the title report to a lender from the requestor.

23. The method of claim 22 further comprising the step of generating a flow chart indicating a chain of title of the real property.

24. The method of claim 22 wherein the title report comprises information related to any of the following for owners of the real property: bankruptcy information, divorce information, tax liens, and judgment liens.

25. The method of claim 22 further comprising the step of sending the lender an electronic notification of the assignment of the title report.

26. The method of claim 22 further comprising the step of imposing a fee to the requestor for processing the request for the title report.

27. The method of claim 22 further comprising the step of imposing a fee to the title company upon acceptance of the request.

28. A method of processing information used in a financial transaction, said method comprising the steps of:
(a) receiving a request to order an appraisal for real property from a requestor;
(b) generating an electronic notification of the request to an appraiser;
(c) receiving an acceptance from the appraiser to the request;
(d) receiving and storing in an electronic database the appraisal from the appraisal; and
(e) receiving a request to assign the appraisal to a lender from the requestor.

29. The method of claim 28 further comprising the step of generating an electronic notification of the assignment to the lender.

30. The method of claim 28 further comprising the step of receiving an approval or rejection of the appraisal from the lender.

31. The method of claim 28 further comprising the step of receiving a request to order a review of the appraisal from the lender.

32. The method of claim 30 further comprising the step of transmitting an electronic notification regarding the acceptance or rejection of the appraisal by the lender to the requestor.

33. A method of facilitating interaction between participants in a financial transaction, said method comprising the steps of:
maintaining an electronic database accessible to brokers, lenders, appraisers and title companies from remote computer terminals via a computer network;
receiving and storing information regarding the financial transaction from any of said brokers, lenders, appraisers and title companies in the electronic database via the computer network; and
providing any of said information to any of said brokers, lenders, appraisers and title companies upon request via the computer network.

34. The method of claim 33 further comprising the step of ordering credit information from a credit agency on request from a broker and storing the credit information in the database.

35. The method of claim 34 further comprising the step of restricting access to the information in the database.

36. The method of claim 33 further comprising the step of tracking changes to the information stored in the database.

37. The method of claim 33 wherein the information comprises a loan application.

38. The method of claim 33 further comprising the step of tracking changes to the information in the database.

39. The method of claim 33 further comprising the step of receiving requests from the brokers to legally assign information stored in the database.

40. The method of claim 33 further comprising the step of assessing charges for accessing the information.

41. The method of claim 33 wherein the information comprises photos of a subject property.

42. A system for facilitating a financial transaction, said system comprising:
an electronic database;
a computer terminal in communication with the electronic database having computer code running thereon and operable to:
(a) receive and store a first credit report for a borrower in the electronic database from a credit agency;
(b) receive an updated credit report for the borrower from the credit agency;
(c) track changes between the first credit report and the updated credit report; and
(d) generate upon request a visual display indicating changes between the first credit report and the updated credit report.

43. The system of claim 42 wherein the computer terminal in communication with the electronic database having computer code running thereon is further operable to store supporting documentation for any changes between the first credit report and the updated credit report in the electronic database.

44. The system of claim 43 wherein the computer terminal in communication with the electronic database having computer code running thereon is further operable to display the supporting documentation in response to a request.

45. The system of claim 44 wherein the supporting documentation is stored in PDF format.

46. The system of claim 42 wherein the computer terminal in communication with the electronic database having computer code running thereon is further operable to receive a request to order the first credit report from a loan officer.

47. The system of claim 46 wherein the computer terminal in communication with the electronic database having computer code running thereon is further operable to receive the request electronically.

48. A system for processing information used in a financial transaction, said system comprising:
an electronic database;
a computer terminal in communication with the electronic database having computer code running thereon and operable to:
(a) receive a request to order a title report for real property from a requestor;
(b) generate an electronic notification of the request to a title company;
(c) receive an acceptance from the title company to the request;
(d) receive and store in the electronic database the title report; and
(e) receive a request to assign the title report to a lender from the requestor.

49. The system of claim 48 wherein the computer terminal in communication with the electronic database having computer code running thereon is further operable to generate a flow chart indicating a chain of title of the real property.

50. The system of claim 48 wherein the title report comprises information related to any of the following for owners of the real property: bankruptcy information, divorce information, tax liens, and judgment liens.

51. The system of claim 48 wherein the computer terminal in communication with the electronic database having computer code running thereon is further operable to send an electronic notification of the assignment of the title report to the lender.

52. The system of claim 48 wherein the computer terminal in communication with the electronic database having computer code running thereon is further operable to impose a fee on the requestor for processing the request for the title report.

53. The system of claim 48 wherein the computer terminal in communication with the electronic database having computer code running thereon is further operable to impose a fee on the title company upon acceptance of the request.

54. A system of processing information used in a financial transaction, said system comprising:
an electronic database;
a computer terminal in communication with the electronic database having computer code running thereon and operable to:
(a) receive a request to order an appraisal for real property from a requestor;
(b) generate an electronic notification of the request to an appraiser;
(c) receive an acceptance from the appraiser to the request;
(d) receive and store in the electronic database the appraisal from the appraiser; and
(e) receive a request to assign the appraisal to a lender from the requestor.

55. The system of claim 54 wherein the computer terminal in communication with the electronic database having computer code running thereon is further operable to generate an electronic notification of the assignment to the lender.

56. The system of claim 54 wherein the computer terminal in communication with the electronic database having computer code running thereon is further operable to receive an approval or rejection of the appraisal from the lender.

57. The system of claim 54 wherein the computer terminal in communication with the electronic database having computer code running thereon is further operable to receive a request to order a review of the appraisal from the lender.

58. The system of claim 56 wherein the computer terminal in communication with the electronic database having computer code running thereon is further operable to transmit an electronic notification regarding the acceptance or rejection of the appraisal by the lender to the requestor.

59. A system of facilitating interaction between participants in a financial transaction, said system comprising:
an electronic database;
a computer terminal in communication with the electronic database having computer code running thereon and operable to:
maintain the electronic database accessible to brokers, lenders, appraisers and title companies from remote computer terminals via a computer network;
receive and store information regarding the financial transaction from any of said brokers, lenders, appraisers and title companies in the electronic database via the computer network; and
provide any of said information to any of said brokers, lenders, appraisers and title companies upon request via the computer network.

60. The system of claim 59 wherein the computer terminal in communication with the electronic database having computer code running thereon is further operable to order credit information from a credit agency on request from a broker and store the credit information in the electronic database.

61. The system of claim 60 wherein the computer terminal in communication with the electronic database having computer code running thereon is further operable to restrict access to the information in the electronic database.

62. The system of claim 59 wherein the computer terminal in communication with the electronic database having computer code running thereon is further operable to track changes to the information stored in the electronic database.

63. The system of claim 59 wherein the information comprises a loan application.

64. The system of claim 59 wherein the computer terminal in communication with the electronic database having computer code running thereon is further operable to track changes to the information in the electronic database.

65. The system of claim 59 wherein the computer terminal in communication with the electronic database having computer code running thereon is further operable to receive requests from the brokers to legally assign information stored in the electronic database.

66. The system of claim 59 wherein the computer terminal in communication with the electronic database having computer code running thereon is further operable to assess charges for accessing the information.

67. The system of claim 59 wherein the information comprises photos of a subject property.
